(19) United States
(12) Patent Application Publication
(10) Pub. No.: US 2014/0036616 A1
(43) Pub. Date: Feb. 6, 2014

(54) DISPENSING AND MIXING SYSTEMS

(71) Applicant: Common Sense, LLC, Los Angeles, CA (US)

(72) Inventors: Dipaknar Ghosh, Irvine, CA (US); John Wallace Berger, Laguna Niguel, CA (US); Joseph Fazio, Irvine, CA (US); Michael George Idaomi, Oak Park, CA (US); Maxwell Aaron Kotlarchyk, Costa Mesa, CA (US); Tuyen Quang Nguyen, Buena Park, CA (US)

(73) Assignee: Common Sense, LLC, Los Angeles, CA (US)

(21) Appl. No.: 13/958,199

(22) Filed: Aug. 2, 2013

Related U.S. Application Data
(60) Provisional application No. 61/791,777, filed on Mar. 15, 2013.
(60) Provisional application No. 61/679,722, filed on Aug. 4, 2012.

(51) Int. Cl. B01F 13/00

(52) U.S. Cl. CPC B01F 13/0027
USPC 366/129; 366/177.1; 366/152.5

(57) ABSTRACT

The present invention relates to devices for dispensing and mixing multi-component materials, in particular for viscous fluid materials. The device is adapted for dispensing multi-component compositions that are kept separate prior to use and that are also typically mixed prior to use to properly combine the constituents in order to form an active and/or working composition. In one embodiment, a device is adapted to contain at least one vessel containing a material prior to use. The device also includes a mechanism for evacuating the at least one vessel and a mechanism for mixing at least one material prior to use. The material may contain multiple constituents in one vessel or more than one vessel.

### CROSS-REFERENCE TO RELATED APPLICATIONS

This application claims the priority and benefit of U.S. provisional patent application Ser. No. 61/679,722, filed Aug. 4, 2012, entitled “DISPENSING AND MIXING SYSTEMS”, and of U.S. provisional patent application Ser. No. 61/791,777, filed Mar. 15, 2013, entitled “DISPENSING AND MIXING SYSTEMS”, the contents of all of which are hereby incorporated by reference in their entirety.

### FIELD OF THE INVENTION

The present invention is related to devices for storing, mixing and/or dispensing viscous materials. In particular, the invention relates to motorized, portable devices for dispensing and mixing multi-component materials.

### BACKGROUND

Various devices exist in the prior art for dispensing and mixing multi-component materials, in particular, viscous fluids, such as dental impression materials, dentifrices, whitening compositions, adhesives, cleaning fluids and the like.

Multi-barreled or multi-compartment devices are often utilized to store the multiple components of a composition and may also be used to mix and dispense the composition for use. As it is typically desired to keep the components separate to prevent any premature interaction, it is important for a device to incorporate features that maintain the integrity of the composition during storage.

Many motorized devices make use of pistons or plungers to force material out of storage vessels or packages, such as barrels, collapsible bags or other such containers. While these systems are capable of dispensing materials, they tend to be large. Complex or separate mechanisms are also often required to utilize powered mixing devices when coupled with a piston or plunger dispensing system since they operate under different mechanical circumstances.

Motorized devices also tend to be large to accommodate motorized mechanisms and gears so that they are not easily portable and operated by an operator's hand. Thus small portable devices tend not to be motorized.

### SUMMARY OF THE INVENTION

The present invention relates to compact, motorized portable devices for dispensing and mixing multi-component materials, for example, viscous fluid materials. The device is adapted for dispensing multi-component compositions that are kept separate prior to use and that are also typically mixed prior to use to properly combine the constituents in order to form an active and/or working composition, such as dental impression materials. In one embodiment, the device may be a handheld device. The composition may be kept in at least one non-flexible or flexible vessel, which may have at least one or dual compartments, having an inlet end and outlet end. For one-compartment vessels, dual vessels are used.

The device for dispensing and mixing components of an admixture may include a chassis for supporting two compartments or vessels for containing two materials to be mixed, each compartment or vessel having an inlet end and an outlet end and may be connected to each other towards the inlet end or the outlet end, though such connections may not lead to communication between the compartments or vessels or mixing of the materials of the compartments or vessels prior to the materials leaving the compartments or vessels. A drive mechanism may be adapted to drive one or both compartments or vessels for evacuating the materials from both compartments or vessels simultaneously, but the ratio of materials being evacuated may be one to one, or one to multiples of one. For example, each compartment or vessel may include an evacuating component such as an actuator that may be utilized to push material out of the compartment or vessel. The evacuating components of each compartment or vessel may also be connected such that driving one evacuating component also drives the other evacuating component(s). The drive mechanism may be connected to one of the evacuating components of one of the compartment or vessels, which may then drive the other evacuating component(s) when they are connected. For another example, the evacuating components may be attached to the drive mechanism and separable from the vessels or compartments, and may act on the vessels or compartments to push material out. A mixing element may be attached to the outlet end of one or both vessels or compartments for receiving the material evacuated from the vessels or compartments. The mixing element may be driven by a second drive mechanism. In one embodiment, the device may also include at least two pulse modulation controls for separately controlling the drive mechanism for evacuating and the drive mechanism for the mixing element. A microprocessor in communication with the pulse modulation controls may be used for varying the speed of evacuation and mixing based on the types of materials, for example, a low viscosity material, a medium viscosity material or a high viscosity material. In another embodiment, the device may also include one pulse modulation control for controlling the drive mechanism for evacuating and not the drive mechanism for the mixing element.

In one aspect, the device may in general utilize a linear drive mechanism to evacuate the materials. Linear drive mechanisms may in general include any appropriate mechanisms which may convert a mechanical input into linear motion, such as, for example, converting rotational input into linear input, to push the materials out of the at least one flexible or non-flexible vessel or compartment.

In one exemplary embodiment, the device may in general utilize a ball screw mechanism to evacuate the material which may include a motorized mechanism for evacuating the material and for mixing the material prior to use.

In another exemplary embodiment, the device may include a pinion and rack drive mechanism to evacuate the material which may include a motorized mechanism for evacuating the material and for mixing the material prior to use.

In other embodiments, the device may in general utilize other mechanisms that may convert a mechanical input into linear motion, to evacuate the material which may include a motorized mechanism for evacuating the material and for mixing the material prior to use.

The device may include at least one vessel. In one embodiment, the vessel may include at least one compartment including a body having an inlet open end for receiving an evacuation mechanism and an outlet opening for dispensing a material. The compartment extends between the open end and the outlet opening. For a single compartment vessel, the device may include at least two such vessels which may be separately formed and arranged side by side in the device, either connected or separated, or the vessels may be integrally formed. In another embodiment, the vessel may be a dual compartment vessel, and each compartment may include a body having an inlet open end for receiving an evacuation mechanism and an outlet opening for dispensing, and each compartment extends between the open end and the outlet opening. The compartments may be separately formed and connected, and arranged side by side in the device, or the compartments may be integrally formed to be side by side.

The motorized mechanism may include at least two motors, one for evacuating and one for mixing the material. Examples of motors may include a pneumatic motor, an ultrasonic motor (USM), a hydraulic drive or any appropriate mechanical power source.

In one embodiment, the device includes a dual vessel or a dual compartment vessel, one of which is a master vessel or compartment and the other being a slave or follower. The mechanism for evacuating may thus include one motor that drives the dispensing or evacuating mechanism for the master vessel or compartment to effect the dispensation of both the master vessel or compartment and slave vessel or compartment. This embodiment is mechanically simpler with fewer parts for facilitating the evacuating mechanism, for example, the ball screw mechanism is only present in the master vessel or compartment and not in the slave or follower vessel or compartment. A connecting bar and/or other connection may connect the two vessels or compartments towards the inlet end or the outlet end. In one example, the master and slave vessels or compartments may generally include an evacuating component, such as an actuator, to act on each or one of the vessels or compartments, for pushing material out of both of the vessels or compartments. For example, an evacuating component for the master vessel or compartment may be driven by a drive mechanism, with the evacuating component of the slave vessel or compartment following, such as by being connected to the evacuating component of the master vessel. In another example, the evacuating components, such as the actuators, may also be separate from the vessels or compartments, as noted before, such as by being connected to the drive mechanism and part of the device, and may then act on the vessels or compartments to push out material. The master evacuating component may thus be driven by the drive mechanism, with the slave evacuating component being attached to the master evacuating component, such as by a connecting rod or bar, and may thus follow the master evacuating component.

In another embodiment, the mechanism for evacuating may include one motor that drives the dispensing mechanism for both of the vessels or compartments, thus both are master vessels or compartments.

In one aspect, the vessel may be substantially cylindrical and/or otherwise possessing a substantial linear dimension along an axis. In another aspect, the vessel may be substantially elliptical.

The device may, in general, include a chassis, for example, so that the components of the device may be supported or located. The chassis may include different sections, for example, a front section, a mid-section, a rear section, or a bottom section, for locating or supporting various component portions. Various sections may or may not also include a housing cover, In general, the chassis may include vessel portions for the vessels, at least two motor portions for the motors and associated gearing mechanisms, and a portion for mounting a mixing device, if desired. The vessel portions and the motor portions may be supported or located close to each other, for example, in the same section, or they may be in different sections of the chassis. In one embodiment, the vessel portion and the motor portion may both be supported or located in the front section of the chassis. In another embodiment, the vessel portion may be supported or located in the front section of the chassis, and the motor portion may be supported or located close by, for example, in the mid-section, or front end of the rear section, of the chassis, The motor section may also be covered with a housing cover. In a further embodiment, the vessel portion may be supported or located in the front section of the chassis, and the motor portion may be supported or located in the rear section of the chassis. In yet a further embodiment, the vessel portion may be supported or located in the front section of the chassis, while the motor portion may be supported or located in the bottom section of the chassis. The bottom section of the chassis may also be covered with a housing cover to form a handle for handling the device during use. In any of the embodiments above, the vessel portion and the mixer portion are generally supported or located in the same section or adjacent section of the chassis.

Also, the chassis may include container like portions for receiving the vessel or compartments if the vessels or compartments are flexible and/or collapsible. The chassis itself may also include collapsible, expandable and/or otherwise adjustable sections that may be utilized to adjust the length or width of the portions for housing of the vessel or compartment of different size and length, or for minimizing the size of the device when the vessels or compartments are emptied or unloaded, as discussed further below. The adjustable sections may utilize any appropriate adjustment mechanisms, which may include, but are not limited to contracting and expanding like an accordion, telescoping, stepping, sliding and/or any other appropriate mechanisms. Other housing designs are also contemplated that may be adapted for particular embodiments of a dispensing and/or mixing device.

In an exemplary embodiment, the device may be adapted to store and evacuate two vessels. In another exemplary embodiment, the device may be adapted to store and evacuate a two-compartment vessel. In one embodiment, the two vessels or compartments may be substantially similar in size and shape. In other embodiments, the vessels or compartments may be dissimilar in at least one characteristic. In either embodiment, the vessels or compartments may each contain a material prior to use and may be of equal or different size. Having equal size vessels or compartments generally means dispensing and mixing mixtures of equal proportion from each vessel or compartment and having unequal size compartments and vessels generally means dispensing and mixing mixtures of unequal proportions from each vessel or compartment.

For example, two vessels may be utilized that may be substantially cylindrical, but of different diameter. This may result in differing volumes of contained material and may thus result in varying mixing ratios when the materials are dispensed for mixing.

In one embodiment of the invention, the device may include features, such as thrust bearings and bearing sleeves, for reducing friction. The friction reduction makes it possible for a more compact device.

In another embodiment of the invention, the device may also incorporate features to allow for automatic detection of cartridge or vessel type, for example, various diameter or length vessels for containing different volumes of material.

In yet another embodiment of the invention, the device may include a sensor mechanism adapted for sensing the viscosity of the material, for example, light body, medium body or heavy body and is versatile enough to allow proper dispensing of the different materials, for example, to maintain a constant speed of evacuation for different materials having different viscosities.

In a further embodiment of the invention, the chassis type design may allow for variable geometries of cartridges or vessels or even different arrangements of the components.

In yet a further embodiment of the invention, the device may include features for energy storage and recovery.

In one aspect, the vessels may be situated side by side, but substantially separate from each other. In another aspect, one vessel may have multiple compartments or chambers so that the compartments may be joined by a common wall. The proper distance of separation of the vessels or compartments may also aid in minimizing contamination of the remaining portions of the material after each use due to, for example, backflow.

A dynamic mixing tip may be located at the outlet end of the at least one vessel or compartment, having at least one opening into the body of the mixing tip. The mixing tip may be driven by a separate motor independently of the motor for evacuating the material, as noted above.

In general, the dynamic mixer may include a substantially hollow housing which may contain a centrally driven mixing shaft having mixing features, such as, for example, mixing fins, blades, paddles, baffles and/or any other appropriate mixing features which may include those with complex profiles and may be arranged in various geometries. The housing may have at least one inlet and at least one outlet for a material to pass into and out of the housing.

The hollow housing of the mixer is the main body portion of the mixer may have a top portion and a base portion and be attached and/or mounted to a base portion which may generally interface with the outlet port or ports of the compartment(s) or vessel(s) of a dispensing and mixing device. The base portion is the portion closer to the outlet port or a vessel or compartment and may also generally include locking features which may, for example, be utilized to aid in attaching and/or retaining the mixing tip on the dispensing and mixing device securely when in use.

For example, the mixer may be in general adapted to interface with at least one outlet port of a compartment or vessel of a dispensing and mixing device. The inlet ports of the mixer may in general be shaped such that they may form a secure and/or fluid-tight connection with the outlet ports of the compartments or vessels of a dispensing and mixing device when in use.

The mixing elements may generally be propelled or may otherwise utilize motion to aid in mixing and be driven by interfacing with or attached to the mixing shaft.

In one aspect, the mixing tip includes a main body portion having located therein a centrally driven mixing shaft including a series of complex profile mixing elements, a cap covering one end of the main body and having one or two inlet openings, a holding area proximate the inlet openings and an outlet at the opposite end of the body. In one embodiment, the inlet openings are adapted to be combined with the outlet ends of the dual compartments of one vessel. In another embodiment, the inlet openings are adapted to be combined with the outlet ends of two vessels. The material being dispensed enters first into a common holding area prior to entering the body of the mixing tip.

In another aspect, the mixing tip includes a main body portion having located therein a centrally driven mixing shaft including a series of complex profile mixing elements, a cap covering one end of the main body having one or two inlet openings, and an outlet at the opposite end of the body. In one embodiment, the inlet openings are adapted to be combined with the outlet ends of the dual compartments of one vessel. In another embodiment, the inlet openings are adapted to be combined with the outlet ends of two vessels. The material being dispensed enters directly into the body of the mixing tip.

The mixer is adapted for mixing the material as it is dispensed from the either the holding chamber, if there is one, or if there is no holding chamber, from the vessels or compartments, to mix more than one material as they are dispensed from their respective compartments or vessels by rotation. The mixing shaft may be rotated either clockwise or counterclockwise.

The mixing shaft having complex profile mixing elements may be supported inside the main body portion by connecting to the motor driving the elements through a centrally located opening in the cap. The mixing shaft extends substantially the length of the main body and connected to the driving motor at one end and freely rotating at the other end.

For desktop motorized dispensing systems, one or more large, powerful heavy motors are generally used for better dispensing and mixing, resulting in a large and heavy system. To put together a compact, light weight, portable, and even handheld, motorized system, the common wisdom may be to use one rather than two motors as two motor may generally weight more than one. Surprisingly, a two-motor system results in a lighter and more compact system. Separately driving the evacuator and mixing tip allows for simpler gearing systems and helps to minimize the number of parts and hence minimizes the weight of the system.

In addition, it is found that two small and light weight motors, under proper arrangements, may even be more powerful than one larger and heavier motor, resulting in a better dispensing and mixing device.

In general, a dynamic mixer in operation may include a linear velocity component and a rotational velocity component. Linear velocity component generally represents the rate the material is being dispensed or evacuated out of the mixer while the rotational velocity component generally represents how thoroughly the materials are being mixed in the mixer prior to being evacuated out of the mixer. Each design of mixing elements generally has a residence time in the mixer during which the material is mixed. If the linear velocity component is too high, the material may not be mixed well. On the other hand, if the rotational component is too high, the dispensing or evacuation speed may be too low in practice. Thus, a dimensionless factor, for example, a churn factor (η), may be defined as a ratio of the rotational velocity (ρ) divided by a linear velocity (τ). Logically, the churn factor is related to the design of the mixing elements, and thus the residence time.

The mixing capability of the mixing tip may be optimized by adjusting the ratio between the rotational and translational speed of the mixing and driving shaft.

For designs of mixing elements that allows for short residence times, the residence times may be increased by interposing a reverse-auger type mixing element and/or other flow slowing elements in the design.

According to one exemplary embodiment of the invention, within the hollow interior and positioned along the length of the mixing shaft are mixing blades having complex profiles and extending asymmetrically from the driving mixing shaft, for example, out of the mixing shaft. Each blade may, for example, have a different profile from one or more of the other blades.

In one embodiment of the invention, towards the entrance of the mixer and arranged about the driving mixing shaft may be a spinning wheel-like section having shearing spokes. In one aspect, at least four shearing spokes may be present at substantially equal intervals about the mixing shaft. In another aspect, at least five shearing spokes may be arranged at substantially equal intervals about the mixing shaft. In a further aspect, at least six sheering spokes may be substantially evenly arranged about the mixing shaft. In yet another aspect, a number of sheering blades or spokes may be arranged at irregular intervals about the mixing shaft. The shearing spokes aid to divide or cut up the continuous strings of materials into smaller pieces or chunks prior to entering the mixer. In one embodiment, the spinning wheel-like section may have one tier. In another embodiment, the spinning wheel-like section may have a double tier arrangement. In one aspect, the two tiers are separated, except to the connection to the mixing shaft. In another aspect, the two tiers are connected with spokes about the peripheral of the tiers. In a further aspect, the two tiers are connected with connecting spokes that are at a distance away from the peripheral.

In another embodiment of the invention, towards the entrance of the mixer and arranged about the mixing shaft may be two loop-like features arranged at 180° from each other and separated by two complex spokes, dividing the loop-like features. These sheering spokes aid in shearing or dividing the continuous strings of material into smaller pieces or chunks prior to entering the mixer.

In a further embodiment of the invention, towards the entrance of the mixer and arranged about the mixing shaft are a plurality of spokes radiating outwardly from the mixing shaft, each spoke having a length, a width and a small thickness, with the width along the length of the housing. In one aspect, there may be at least four spokes. In another aspect, there may be at least five spokes. In a further aspect, there may be at least six spokes. In yet another aspect, there may be at least seven spokes. In one embodiment, the spokes may be blade like, with a taper at the end to accommodate the cone shape housing. In another embodiment, the spokes may be blade like with portions of the blade being fin-like features. In one aspect, the fin-like features may extend about one-half the length of the blades from the mixing shaft. In another aspect, the fin-like features may extend more than about three-fourths the length of the blades from the mixing shaft.

Adjacent to the shearing spokes may be present at least one section of mixing elements having, for example, at least two portions extending from the mixing shaft; more for example, at least three portions extending from the mixing shaft; even more for example, at least four portions extending from the mixing shaft; and still more for example, at least five portions extending from the mixing shaft. In one embodiment, the portions may be spaced in regular interval on the mixing shaft. In another embodiment, the portions may be spaced at irregular intervals on the mixing shaft. In one aspect, the portions may be short portion, not extending to the wall of the housing. In another aspect, the portions may be long portion, extending substantially to the wall of the housing.

In general, the mixer of the present invention prolongs the residence time of the material in the mixer to achieve better mixing. In some embodiments, blades and/or other mixing features may be utilize to control the residence time of the material, such as by disrupting the flow of material through obstruction, increasing the pressure drop across the mixing element, constricting the volume in sections of the mixing tip, utilizing counter-flow elements such as angled and/or twisted blades, reverse auger designs and/or any other appropriate manner of disrupting the flow of material to increase residence time. These features may be present in any part of the mixing element along the length of the mixing shaft.

Towards the tip or outlet end of the mixer, the mixing shaft may be tapered towards a point in one embodiment. In another embodiment, the mixing shaft may be tapered towards a point with the portion before the point being scalloped to minimize the introduction of air into the material at the dispensing point of the mixer.

In one aspect, the portions may be tapered towards the ends. In another aspect, the portions may be tapered towards the ends with the bottom of the portions being longer than the top of the portion. This section aids to increase the residence time of the material by keeping the material suspended in the zone defined by the sheering spokes and the initial section.

In one embodiment, for example, at least three sections of mixing elements may be present on the mixing shaft; more for example, at least four sections of mixing elements may be present on the mixing shaft; even more for example, at least five of mixing elements may be present on the mixing shaft; and still more for example, six sections of mixing elements may be present on the mixing shaft; each section having, for example, at least two, more for example, at least three portions radiating outwardly from the mixing shaft and arranged along the mixing shaft. The portions may be in a substantially right angle relationship to the mixing shaft. In one aspect, the portions of the sections may be spaced at even intervals around the mixing shaft, and portions of one section being staggered from the portions of at least one other section, by, for example, five to twenty-five degrees; more for example, ten to twenty degrees. In another aspect, the portions of at least one section may be spaced at uneven intervals about the mixing shaft. In yet another aspect, the portions of all sections may be arranged at uneven intervals about the mixing shaft and staggered from the portions of at least one other section, by, for example, five to twenty-five degrees; more for example, by ten to twenty degrees. In a further aspect, the portions of all sections may be arranged at combinations of different intervals about the mixing shaft.

In another embodiment, at least three sections may be present on the mixing shaft; more for example, at least four sections of mixing elements may be present on the mixing shaft; even more for example, at least five of mixing elements may be present on the mixing shaft; and still more for example, six sections of mixing elements may be present on the mixing shaft; each sections having two or more portions radiating outwardly from the mixing shaft and arranged along the mixing shaft, some of the portions may make an acute angle with the horizontal, extending either upwards or downwards from the horizontal, or combinations thereof. In one aspect, the portions of the sections may be spaced at even intervals around the mixing shaft, and portions of one section being staggered from the portions of at least one other section, by, for example, five to twenty-five degrees; more for example, ten to twenty degrees. In another aspect, the portions of at least one section may be spaced at uneven intervals about the mixing shaft. In yet another aspect, the portions of all sections may be arranged at uneven intervals about the mixing shaft and staggered from the portions of at least one other section, by, for example, five to twenty-five degrees; more for example, by ten to twenty degrees. In a further aspect, the portions of all sections may be arranged at combinations of different intervals about the mixing shaft.

In yet another embodiment, at least three sections may be present on the mixing shaft; more for example, at least four sections of mixing elements may be present on the mixing shaft; even more for example, at least five of mixing elements may be present on the mixing shaft; and still more for example, six sections of mixing elements may be present on the mixing shaft; each sections having two or more portions radiating outwardly from the mixing shaft and arranged along the mixing shaft, with the portions of at least one of the sections at a substantially right angle relationship with the mixing shaft and some of the portions of at least one section making an acute angle with the mixing shaft, extending downwards from the horizontal. In one aspect, the portions of the sections may be spaced at even intervals around the mixing shaft, and portions of one section being staggered from the portions of at least one other section, by, for example, five to twenty-five degrees; more for example, ten to twenty degrees. In another aspect, the portions of at least one section may be spaced at uneven intervals about the mixing shaft. In yet another aspect, the portions of all sections may be arranged at uneven intervals about the mixing shaft and staggered from the portions of at least one other section, by, for example, five to twenty-five degrees; more for example, by ten to twenty degrees. In a further aspect, the portions of all sections may be arranged at combinations of different intervals about the mixing shaft.

In a further embodiment, at least three sections may be present on the mixing shaft; more for example, at least four sections of mixing elements may be present on the mixing shaft; even more for example, at least five of mixing elements may be present on the mixing shaft; and still more for example, six sections of mixing elements may be present on the mixing shaft; each sections having two or more portions radiating outwardly from the mixing shaft and arranged along the mixing shaft, with the portions of at least one of the sections at a substantially right angle relationship with the mixing shaft and some of the portions of at least one section making an acute angle with the mixing shaft, extending upwards from the horizontal. In one aspect, the portions of the sections may be spaced at even intervals around the mixing shaft, and portions of one section being staggered from the portions of at least one other section, by, for example, five to twenty-five degrees; more for example, ten to twenty degrees. In another aspect, the portions of at least one section may be spaced at uneven intervals about the mixing shaft. In yet another aspect, the portions of all sections may be arranged at uneven intervals about the mixing shaft and staggered from the portions of at least one other section, by, for example, five to twenty-five degrees; more for example, by ten to twenty degrees. In a further aspect, the portions of all sections may be arranged at combinations of different intervals about the mixing shaft.

In still another embodiment, at least three sections may be present on the mixing shaft; more for example, at least four sections of mixing elements may be present on the mixing shaft; even more for example, at least five of mixing elements may be present on the mixing shaft; and still more for example, six sections of mixing elements may be present on the mixing shaft; with portions of each section making a combinations of any of the above embodiments. In one aspect, the portions of the sections may be spaced at even intervals around the mixing shaft, and portions of one section being staggered from the portions of at least one other section, by, for example, five to twenty-five degrees; more for example, ten to twenty degrees. In another aspect, the portions of at least one section may be spaced at uneven intervals about the mixing shaft. In yet another aspect, the portions of all sections may be arranged at uneven intervals about the mixing shaft and staggered from the portions of at least one other section, by, for example, five to twenty-five degrees; more for example, by ten to twenty degrees. In a further aspect, the portions of all sections may be arranged at combinations of different intervals about the mixing shaft.

In yet a further embodiment, at least three sections may be present on the mixing shaft; more for example, at least four sections of mixing elements may be present on the mixing shaft; even more for example, at least five of mixing elements may be present on the mixing shaft; and still more for example, six sections of mixing elements may be present on the mixing shaft; such as in any of the above embodiments, with the portions of at least one section being constructed to having a reverse auger function. The reverse auger function aids in the mixing of the materials by extending the residence time of the material inside the housing, though not to inhibit the dispensing of the material. In one aspect, the portion or portions of the auger section may be shaped like a screw or propeller, and arranged in about a half spiral. In another aspect, the portion or portions of the auger section may be shaped like a screw or propeller, and arranged in less than a three-quarter spiral. In a further aspect, the portion or portions of the auger section may be partial twisted blade-like portions. According to one embodiment of any of the above embodiments, the reverse auger portion may be present in the middle of the sections. According to another embodiment of any of the above exemplary embodiments, the reverse auger portion may be present closer to the inlet than the outlet of the mixing tip. In one aspect, the portions of the sections may be spaced at even intervals around the mixing shaft, and portions of one section being staggered from the portions of at least one other section, by, for example, five to twenty-five degrees; more for example, ten to twenty degrees. In another aspect, the portions of at least one section may be spaced at uneven intervals about the mixing shaft. In yet another aspect, the portions of all sections may be arranged at uneven intervals about the mixing shaft and staggered from the portions of at least one other section, by, for example, five to twenty-five degrees; more for example, by ten to twenty degrees. In a further aspect, the portions of all sections may be arranged at combinations of different intervals about the mixing shaft.

In still a further embodiment, the mixing elements may include at least one auger-like section or element disposed thereon in combination with any of the above embodiments of portions. The auger-like section or element may, when rotated by the centrally driven mixing shaft, achieve mixing and may also provide at least a portion of the total driving force to dispense a material. The auger-like section or element may be, for example, towards the inlet end of the mixer. In one aspect, the portions of the sections may be spaced at even intervals around the mixing shaft, and portions of one section being staggered from the portions of at least one other section, by, for example, five to twenty-five degrees; more for example, ten to twenty degrees. In another aspect, the portions of at least one section may be spaced at uneven intervals about the mixing shaft. In yet another aspect, the portions of all sections may be arranged at uneven intervals about the mixing shaft and staggered from the portions of at least one other section, by, for example, five to twenty-five degrees; more for example, by ten to twenty degrees. In a further aspect, the portions of all sections may be arranged at combinations of different intervals about the mixing shaft.

In one exemplary embodiment, the portions may be shaped evenly in thickness and width.

In another exemplary embodiment, at least some of the portions may be shaped evenly in thickness and width except at the end, which may be tapered in thickness or width. In one aspect, the end may be tapered and blade like. In another aspect, the end may be shaped like a winglet. In a further aspect, the end may be in the form of a T-section or L-section. In yet another aspect, the ends may be a combination of any of the above shapes.

In some exemplary embodiments, the portions may be shaped and/or oriented to contact and/or closely follow the contours of the interior of the mixing tip such that, for example, they may scrape material away from the walls of the mixing tip interior to, for example, aid in thorough mixing and/or prevent dead zones. The portions may be shaped to contour to the interior of the mixing tip along only a section of the portion, such as with a T- or L-section, or they may also contour along substantially the entire portion, such as with an angled and/or shaped portion.

In a further exemplary embodiment, at least some of the portions may be shaped like fins, blades, baffles and/or any other appropriate mixing features. Some of the shaped portions may, for example, be flow influencing elements which may generally alter the overall flow of material in the mixing tip by, for example, acting in a propelling or conveying manner or in a counter-flowing propelling or conveying manner (i.e. against the overall flow direction of the material). Some of the shaped portions may thus, for example, resemble propellers, screws and/or any other flow-influencing shape which may generally be shaped such that portions may transect the horizontal plane.

In general, the portions or spokes aid in interruption the even flow of material through the housing of the mixer, as noted above. The more disruption of the flow, the higher the residence time and the better the mixing quality of the material at the exit port of the mixer. In one embodiment, the T-section ends aid in inhibiting material from slipping by the spokes along the inner surface of the housing and further aids to reintroduce the material back into the mixer housing. In another embodiment, reverse auger portions may be used, either alone or in combination with T-shaped or any other shape portions to increase the residence time of the material in the mixer.

The mixing portions may extend to substantially touching the inside of the housing so as to scrap off any material that may be deposited there.

In general, materials for mixing and dispensing may generally enter the mixing tip, for example, at the inlet port or ports. The flows of materials may then enter the hollow interior of the housing where the mixing elements or portions may generally combine and/or mix the materials by cutting through the flows and directing them in multiple directions within the hollow interior before exiting through the outlet opening 306.

In one embodiment, the mixing element may initially cut up the flows of materials using a sweeping element near and/or adjacent to the inlet port or ports, such as with leading edges as the mixing element rotates. The materials may be further mixed and/or cut up by the other blade elements of the subsequent sections or tiers before flowing through and around the cutouts of the output end of the mixing tip. When the mixing tip is in the shape of a funnel, the portions of the last section are correspondingly shorter than those in the preceding sections.

In another embodiment, the output end of the mixing shaft may include a plurality of fin-like portions that are rendered discontinuous, and spirally emanating from the outside surface of the mixing shaft. A first pair of opposing fin-like portions include a first number of slots which divide each portion of the first pair of portions into a first number of component portions, and second pair of opposing fin-like portions include a second number of one or more portion slots which divides each portion of the second pair of portions into a second number of portions. The fin-like portions may emanate spirally from the mixing shaft. According to one embodiment, the shaft between the fins may be solid. According to another embodiment, the space between the portions may include slots. In one aspect, the first and second numbers are the same. In another aspect, the first and second numbers are different. These portions may allow for more mixing prior to dispensing.

In one embodiment, the vessel or vessels may be relatively inflexible or stiff and thus are self-supporting and may contain up to about 50, more for example, up to about 100 milliliters of material. In another embodiment, the vessel or vessels may be relatively flexible or collapsible and not self-supporting, thus may need to be otherwise supported.

In one aspect, it may be desirable for the dispensing and mixing device to experience minimal backflow when a dispensing action is completed. For some materials, substantially minimizing the backflow of at least one material being evacuated from at least one vessel is desirable, for example, for material that tends to harden or change when dispensed and/or mixed. With multi-component compositions, substantially minimizing cross-contamination between the components that may result in premature action of the composition, such as, for example, premature curing, which may be deleterious to continued use may also be desirable In one embodiment, the dispensing and mixing device may include a braking mechanism to substantially stop the rotation of the drive mixing shaft and associated gears. This may substantially lock the position of the gears such that the associated vessels may be maintained at a given torque or torsion, which may substantially maintain the applied pressure on the contained materials within the vessels. Maintaining the applied pressure on the vessels may thus aid in reducing backflow. In another embodiment, the inlets to the mixing device may be spatially segregated to minimize cross-contamination. In yet another embodiment, outlet ports of the compartments or vessels are kept at a distance apart. In a further embodiment, the components may be fed into the mixer substantially horizontally to minimize cross-contamination.

The system may include at least one pulse modulation controls, and at least one microprocessor for controlling the motor for dispensing and the motor for mixing, which may operate either independently or concertedly, if desired. A microprocessor may sensed the weight or viscosity of the material to be dispensed and mixed and triggers variable speed feeds to the pulse modulation controls to modulate the speed of the dispensing and mixing motors.

A dispensing and/or mixing device sometimes may use a slider speed selection switch or a mechanical speed switch to allow the user to select the speed of dispensing and/or mixing. The user may need to figure out the proper speed for a particular impression material being dispensed and/or mixed. The optimum speed for a light body impression material, for example, may not be the optimum speed for a heavy body impression material, for example. For example, if a dispensing and/or mixing device that uses a speed switch, when the switch is depressed halfway, the light body material may dispense at a rate quite different than the rate medium or heavy body material may dispense with the switch depressed halfway. Thus, if the user wishes the material to dispense at half the maximum dispensing rate, he/she will have to figure out by trial and error how much to depress the switch. Even with full depression, different materials may also come out at different rates. Thus, the slider speed selection switch may become a complicated system to accommodate different weight materials at different rates to avoid having to perform too much trial and error operations.

The present invention includes a microprocessor which may discern how much a user has depressed the trigger switch and uses a computer algorithm to convert the depression to a modulation signal that ensures that the particular material in the machine is dispensed at the desired rate.

The microprocessor may drive a pulse modulation control and the amount the trigger switch is depressed may result in the same or substantially the same dispensing rate regardless of the viscosity of the material being dispensed. The microprocessor senses the type of impression material loaded in the device, and modulates the pulse width of the motor drive signal to control the dispensing rate. This modulation may be done at a very high frequency so that the effective drive signal of the motor is made higher or lower depending on the amount of modulation.

In one embodiment, the microprocessor may drive the pulse modulation control for the motor for evacuating. In another embodiment, the microprocessor may drive both the pulse modulation controls, if present, for the motor for evacuation and the motor for mixing. In another embodiment, one microprocessor may drive the pulse modulation control for the motor for evacuation and one microprocessor may drive the pulse modulation control for the motor for mixing if used.

Though with two separate motors, the present invention is smaller and quieter than a system having one motor and is also more efficient. In a desktop dispenser, powerful, large and heavy motors are generally used. Surprisingly, the use of two motors enables each motor to be individually matched to the functions to be performed, resulting in a more compact and lighter weight device.

The gearing ratios for each of the motors may be different or the same depending on the similarity or dissimilarity of the motors for optimal performance of the motors. For example, the evacuation motor driving the rotational linear actuator may have a stage one gear ratio matching with a spur gear of about four to six to one, more for example, about five to one and a stage two gear ratio of about eight to twelve to one, more for example, about ten to one; the mixing motor driving the mixer may have a stage one gear ratio matching with a gear head of about ten to fourteen to one, more for example, about twelve to one and a stage two gear ratio matching with a spur gear of about six to ten to one, more for example, about eight to one for getting good performance from the motors without unnecessarily increasing the noise output from the system. The gearing mechanisms may also employ gear heads for the motor(s) which may, for example, be reduction heads.

Utilizing a master and a slave compartment or vessel may also simplify the drive system and contribute to the small size and quietness of the system.

According to one embodiment, the actuation mechanism may include a rotational linear actuator, such as a ball-screw actuator, a roller-screw actuator, any form of nut-screw actuator, a rack and pinion actuator, and/or any other appropriate actuator which may convert the rotational motion of a motor into linear motion for driving a piston rod of the master vessel or compartment, while the follower or slave vessel or compartment is attached to be driven. In one embodiment, one pulse modulation control may be present to control the drive of the actuation mechanism and the mixing mechanism. In another embodiment, one pulse modulation control may be present to control the drive of the actuation mechanism and another pulse modulation may be present to control the drive of the mixing mechanism. The pulse modulation control or controls may be in communication with a microprocessor which may feed the weight of the material to be dispensed to the pulse modulation control for varying the speed of evacuation of the motor. The microprocessor may also control the speed of the motors separately to maximize the efficiency of the motors for a particular type of material, motor, gearing or speed of evacuation. The optimization may also decrease the noise level of the motors.

The device is compact and may be held in the palm of the dental professional, or may include a handle for carrying or handling. The device may be of any external shape. In one embodiment, the dispensing and mixing device may be of a gun-like shape, with a handle like-section for carrying or handling. Some internal components may be located or supported in the handle section. In another embodiment, the dispensing and mixing device may be box-like in shape, with a section adapted to be held in the palm of a hand.

Actuation of the mixing and/or dispensing action may also be controlled by, for example, a trigger and/or other finger control. The actuator maybe a push button-like protrusion located either on top of the device, for a box-like shape device, for easy control when held in the palm of the hand; or towards the top side portion of the handle when the device has a handle. The device may also employ a pedal, such as a foot pedal, which may be wired or wireless, voice control, remote control, and/or any other appropriate control mechanism. The device itself may be powered by an electrical source included inside the chassis, such as, for example, a battery, a capacitor, a transducer, a solar cell, an external source and/or any other appropriate source.

For an internal power source, the device may also include a charging station adapted for coupling to the device during charging. The charging station may be cradle-like, for sitting the device.

In one embodiment, the present invention includes a compact, motorized device for dispensing and mixing components of an admixture of materials, having a chassis for supporting two vessels for containing two materials, each vessel having an inlet end and an outlet end and connected to each other towards the inlet end. A linear drive mechanism adapted to drive one of the two vessels for evacuating the materials from both vessels simultaneously. Attached to the outlet end of each vessel is a mixing element for receiving the material evacuated from the vessels, said mixing element is driven by a second drive mechanism. The motorized device also includes at least one pulse modulation control for controlling the drive mechanism for evacuating, the drive mechanism for the mixing element or both, and a sensor mechanism adapted for sensing the viscosity of the material to allow for proper dispensing of the different materials at a predetermined speed of evacuation.

In another embodiment of the invention, the present invention includes a handheld, motorized device for dispensing and mixing materials, having a drive rod having an external threaded race, a driven rod running parallel to and coupled at a distal end to said drive rod, a drive mechanism including a ball screw mounted about said drive rod, said ball screw having a nut element having an internal helical race; and a plurality of ball bearings disposed between said internal helical race and said external threaded race of said drive rod such that the driven rod is linearly fixed in relation to the drive rod.

In yet another embodiment, the present invention also includes a compact, motorized device for dispensing and mixing components of an admixture of materials having a chassis for supporting two vessels for containing two materials, each vessel having an inlet end and an outlet end and connected to each other towards the inlet end. A linear drive mechanism adapted to drive one of the two vessels for evacuating the materials from both vessels simultaneously. Attached to the outlet end of each vessel is a mixing element for receiving the material evacuated from the vessels, said mixing element is driven by a second drive mechanism. The motorized device also includes at least two pulse modulation controls for separately controlling the drive mechanism for evacuating and the drive mechanism for the mixing element or both, and a microprocessor in communication with the pulse modulation controls for varying the speed of evacuation and mixing based on the type of materials.

The present invention together with the above and other advantages may best be understood from the following detailed description of the embodiments of the invention illustrated in the drawings below.

### BRIEF DESCRIPTION OF THE DRAWINGS

FIG. 1 illustrates a multi-component dispensing and mixing device in one embodiment of the present invention;

FIG. 2 shows a perspective view of the components of the multi-component dispensing and mixing device of FIG. 1;

FIG. 3 shows the components of the driving mechanisms of the multi-component dispensing and mixing device of FIGS. 1 and 2;

FIG. 4 illustrates a gearing and linear actuator in some embodiments of a multi-component dispensing and mixing device;

FIG. 4a illustrates a rack and pinion linear actuator in some embodiments of a multi-component dispensing and mixing device;

FIG. 5 illustrates the components of a driving and gearing mechanism for a mixing tip;

FIGS. 5a and 5b illustrate gearing placement for motors driving a linear actuator and a mixing tip, respectively;

FIGS. 6 and 6a illustrate perspective partial see-through views of a mixing tip having a dynamic mixing element;

FIGS. 7, 7a, 7b and 7c illustrate perspective views of a dynamic mixing element having a plurality of mixing features in some embodiments of the present invention;

FIGS. 8, 9 and 10 illustrate alternative embodiments of dynamic mixing elements having a plurality of mixing features;

FIG. 11 illustrates an embodiment of a dynamic mixing element having a generally planar portion;

FIGS. 12 and 12a illustrate embodiments of tip portions of mixing elements incorporating fin-like structures;

FIGS. 13 and 13a illustrate orientations of mixing features of mixing elements;

FIGS. 14 and 14a show embodiments of the device of the present invention having adjustable chassis;

FIGS. 15 and 15a show the view from above and below, respectively, of the device of the present invention having a hood attached to the drive mechanism;

FIG. 16 shows a perspective front and side view of a compact device in an embodiment of the present invention, having a charging station attached;

FIG. 16A shows a perspective front and side view of the compact device of FIG. 16 without a charging station;

FIG. 16B shows the compact device of FIGS. 16, 16A with the material vessels and mixing tip removed;

FIG. 16C illustrates a charging station in one embodiment of the invention;

FIG. 17 shows a partial cut away view of the device of FIGS. 16, 16A and 16B, showing various components inside the chassis;

FIG. 17A shows a compact device with rigid hollow housings for material vessels;

FIG. 17B shows an embodiment of rigid removable material vessels;

FIG. 17C shows a detailed view of portions of the internal dispensing and mixing mechanisms of the compact device of FIGS. 16, 16A, 16B and 17;

FIGS. 18 and 18A each shows a perspective rear and side view and front and side view of the device of FIGS. 16 and 16B, respectively, in an embodiment of the present invention;

FIG. 18B shows a top view of the device of FIGS. 16 and 16B in an embodiment of the present invention;

FIGS. 18C and 18E show side views of the device of FIGS. 16 and 16B in an embodiment of the present invention;

FIG. 18D shows a bottom view of the device of FIGS. 16 and 16B in an embodiment of the present invention;

FIG. 18F shows a back view of the device of FIGS. 16 and 16B in an embodiment of the present invention; and

FIG. 18G shows a front view of the device of FIGS. 16 and 16B in an embodiment of the present invention.

### DETAILED DESCRIPTION OF THE INVENTION

The detailed description set forth below is intended as a description of the presently exemplified methods and apparatuses provided in accordance with aspects of the present invention, and is not intended to represent the only forms of the present invention. It is to be understood, however, that the same or equivalent functions and components incorporated in the methods and apparatus may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described herein can be used in the practice or testing of the invention, the exemplified methods, devices and materials are now described.

The invention relates to an article of manufacture which is intended for dispensing and/or mixing materials which are components of an admixture and which are kept separate until the admixture is formed. However, the invention is not limited to particular types of material to be stored and dispensed, and may be used for storing and dispensing any material that can be stored within a vessel or a compartment of a dual compartment vessel and effectively mixed by a dynamic mixer.

For desktop motorized dispensing systems, one or more large, powerful heavy motors are generally used, resulting in a large and heavy system. There is generally no limitation on the number or size of motors so long as they are powerful. Generally, the motors also do not run quietly.

To put together a compact, light weight, and portable, for example, handheld, or easily transportable, motorized system, there are limited options for choices of motors. Conventional wisdom may be to use one rather than two motors as two motor may generally weigh more than one. Surprisingly, a two-motor system actually may result in a lighter and more compact system, as mentioned before, when properly constructed. It is found by the present inventors that separately driving the evacuator and mixing tip allows for simpler gearing systems, helps to minimize the number of parts and hence minimizes the weight of the system.

Surprisingly, two small and light weight motors, under proper arrangements, may be more powerful than one larger and heavier motor. These two small motors also run quieter than one larger one. The effectiveness of a device having two small motors is illustrated by the embodiments discussed below.

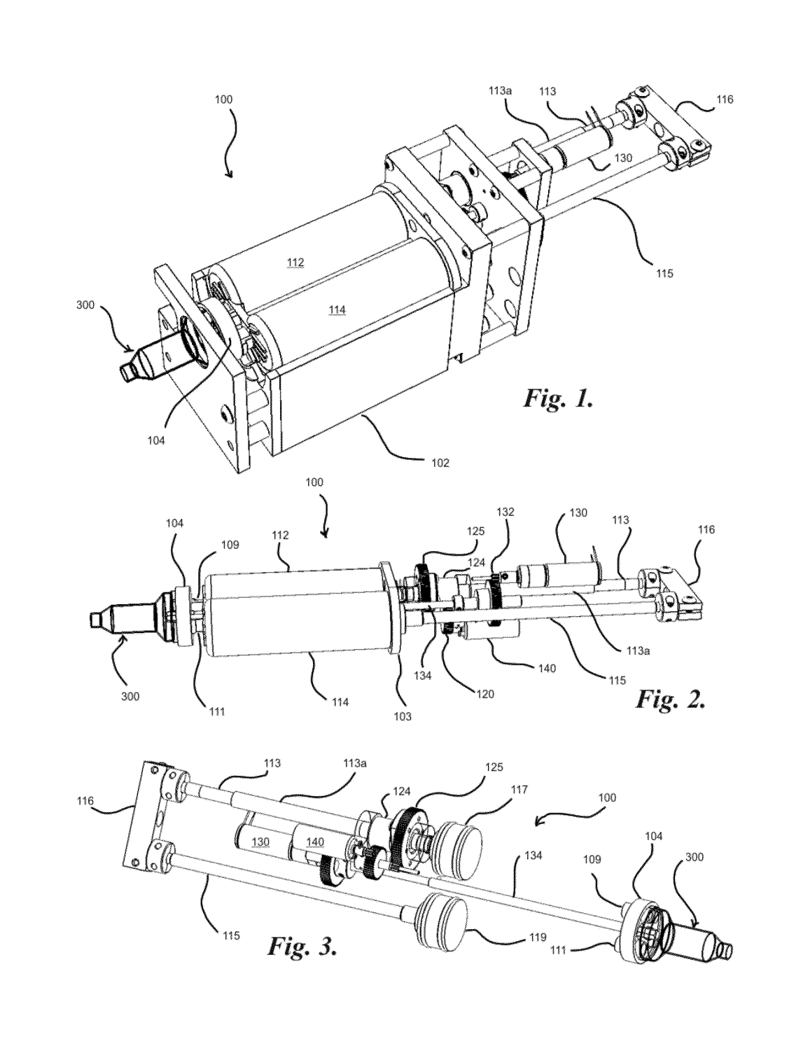

In general, the components of a dispensing and/or mixing device, such as the device 100 illustrated in FIG. 1, may be mounted to and/or in a chassis 102 which may generally serve to retain and/or fix the positions and relationships of some of and/or all of the components of a dispensing and/or mixing device 100. The device 100 may be compact and portable, for example, may be a handheld device, and including a motorized mechanism for, for example, facilitating dispensing and mixing. The device 100 may further generally include and/or interface with at least one vessel, compartment or cartridge, such as the dual compartment or cartridges 112, 114 as illustrated in FIG. 1, which may generally contain and/or store materials for dispensing and/or mixing by the device 100. The dispensing and/or mixing device may further generally include and/or be interfaced with a mixing device, such as the mixing tip 300 as illustrated, for mixing together materials dispensing from the device 100. In some embodiments, the mixing device may further be a dynamic mixing tip which may be driven, such as by a motor 130 as illustrated. Further in general, the dispensing and/or mixing device may include an actuator for forcing materials from the compartments or cartridges.

In some embodiments, the compartments or cartridges, such as the dual compartment or cartridges 112, 114, may generally include a substantially tubular or cylindrical vessel with an outlet end and a thrust end. The outlet end may generally interface with the dispensing and/or mixing device 100 such that material may flow from the vessel into a mixing and/or dispensing tip, such as the tip 300 as illustrated. The thrust end may generally interface with the dispensing and/or mixing device 100 such that an actuator may force the material from the vessel out of the compartment or cartridge. For example, the compartment or cartridge may be adapted to receive a plunger or piston therein which may be actuated to force the material out of the vessel, as illustrated with the piston rods 113, 115, which may be actuated into cartridges 112, 114, respectively. In some embodiments, the piston rods 113, 115 may be driven together by driving one piston rod, such as rod 113, such that the other rod, such as rod 115, is driven along, such as with joining bridge 116 which may connect the piston rods 113, 115. In another embodiment, the piston rods 113, 115 may be driven independently without the need for a joining bridge 116. Each of the piston rods 113, 115 may further include a plunger portion 117, 119, respectively, which may apply pressure to the interior of the cartridges 112, 114, respectively. The material in the cartridges 112, 114 may then be forced out and through the output channels 109, 111, respectively, which may be extended through the mixing tip mounting 104 into the mixing tip 300.

For a flexible or collapsible vessel or cartridge 112, 114, the thrust end may be a closed end of the vessel or cartridge 112, 114, and at least a part of the actuator, such as a plunger or piston rod, may act directly on it to force the material out.

For a rigid vessel or cartridge, the thrust end may be a closed end of the vessel or cartridge that is removable prior to use or movable to receive the actuator, such as a plunger or piston rod, to force the material out. In one embodiment, the part of the actuator acting directly on the open end may be of a size adapted to force substantially all of the material out of the vessel or compartment. In another embodiment, the part of the actuator acting directly on the moveable end of the cartridge or vessel may be similar to that acting directly on the closed end of a flexible or collapsible vessel or cartridge.

In some exemplary embodiments, the actuator may generally include a motorized drive system which may actuate at least one piston rod to force out the material in a vessel, such as with the motor 140 as shown in FIGS. 2 and 3. The motor 140 may directly drive the actuator, or the motor 140 may drive the actuator using a gearing mechanism, such as the gearing mechanism 120 shown in FIG. 2. In general, the gearing mechanism 120 may be optimized to provide the desired amount of actuation while also optimizing the available power of the power source and/or the motor 140.

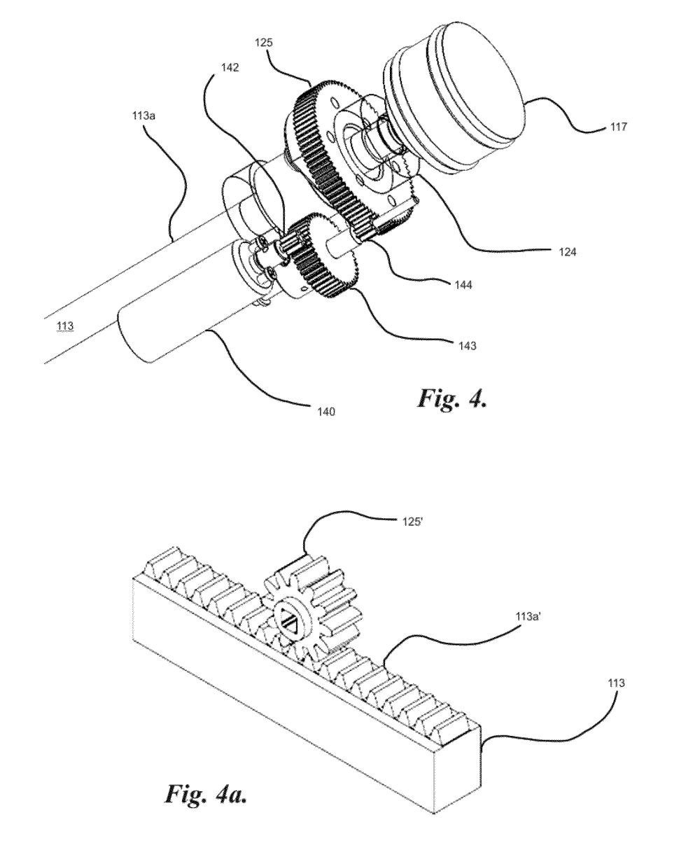

In an exemplary embodiment, the actuation mechanism may include a rotational linear actuator, such as a ball-screw actuator, a roller-screw actuator, any form of nut-screw actuator, a rack and pinion actuator, and/or any other appropriate actuator which may convert the rotational motion of a motor into linear motion for driving a piston rod. As illustrated in FIGS. 2, 3 and 4, a nut-screw actuator may include a nut element 124 and an interfacing surface on at least one piston rod, such as the threaded portion 113a of piston rod 113 as illustrated. In general, the motor 140 may rotate the nut element 124, which through interfacing with the threaded portion 113a, may thus cause the piston rod 113 to advance or retract, depending on the direction of rotation of the motor. For example, a ball-screw actuator may include a substantially helical race within the nut element 124 where ball bearings may roll between the helical race and the threaded portion 113a to translate the rotational motion of the nut element 124 into linear motion of the piston rod 113. For example, as shown in FIGS. 2, 3 and 4, the nut element 124 may generally include and/or be rotationally coupled to a driven gear 125, which may be rotated by the motor 140, such as through a gearing mechanism 120, which may include, for example, an output gear 142, which may be coupled to the output mixing shaft of the motor 140, an intermediate gear 143, and/or a driving gear 144, which may be rotationally coupled to the intermediate gear 143 and may thus be used for stepping up or down the rotational speed transferred to the driven gear 125, as illustrated in FIG. 4. In general, depending on the power of the motor, the power source, the desired speeds, and/or other engineering factors, the gearing mechanism 120 may be adjusted and/or optimized to provide the desired output. In another embodiment, the gearing mechanism may be incorporated in the motor itself as a gear head. In yet another embodiment, the motor and gear mechanism may be replaced with an electrical linear actuator.

In another embodiment, such as illustrated in FIG. 4a, the piston rod 113 may include a rack 113a′ on which a pinion 125′ may rotate by being driven by a motor 140 (not shown) to translate the rotational motion of the pinion 125′ to linear motion of the rack 113a′.

FIG. 1, 2 or 3 illustrates an embodiment of a chassis 102 that may be adapted to mount or support the components of any of the above described dispensing and mixing devices 100. In general, the chassis 102 may include portions for the vessels 112, 114, respectively, a portion for motors 130 and 140 and associated gearing mechanisms, a portion that may house portions of the drive mixing shaft 134, and/or other portions for other components of the device 100. The chassis 102 may also include collapsible, expandable and/or otherwise adjustable sections that may be utilized to adjust the length and/or width of the chassis 102 to accommodate vessels 112, 114 having different lengths or diameters. The adjustable mechanisms may include, but are not limited to telescoping, stepping, sliding and/or any other appropriate mechanisms.

The chassis 102 may be made of metallic or non-metallic material, as long as it provides the structural properties needed to support the various components of the device to be supported. In some embodiments, the chassis 102 may be made of, for example, any suitable metal, for example, aluminum, steel, etc.; or polymeric materials. Suitable polymers may include, but are not limited to, polyethylene, polypropylene, polybutylene, polystyrene, polyester, acrylic polymers, polyvinylchloride, polyamide, or polyetherimide like ULTEM®; a polymeric alloy such as Xenoy® resin, which is a composite of polycarbonate and polybutyleneterephthalate or Lexan® plastic, which is a copolymer of polycarbonate and isophthalate terephthalate resorcinol resin (all available from GE Plastics), liquid crystal polymers, such as an aromatic polyester or an aromatic polyester amide containing, as a constituent, at least one compound selected from the group consisting of an aromatic hydroxycarboxylic acid (such as hydroxybenzoate (rigid monomer), hydroxynaphthoate (flexible monomer), an aromatic hydroxyamine and an aromatic diamine, (exemplified in U.S. Pat. Nos. 6,242,063, 6,274,242, 6,643,552 and 6,797,198, the contents of which are incorporated herein by reference), polyesterimide anhydrides with terminal anhydride group or lateral anhydrides (exemplified in U.S. Pat. No. 6,730,377, the content of which is incorporated herein by reference)or combinations thereof. In general, the better choices are those polymeric materials that do not cause any adverse effects.

The chassis 102 may be manufactured by a variety of methods such as, for example, various molding methods that may include injection-molding, machining, extruding, casting, stamping and/or any other appropriate manufacturing method.

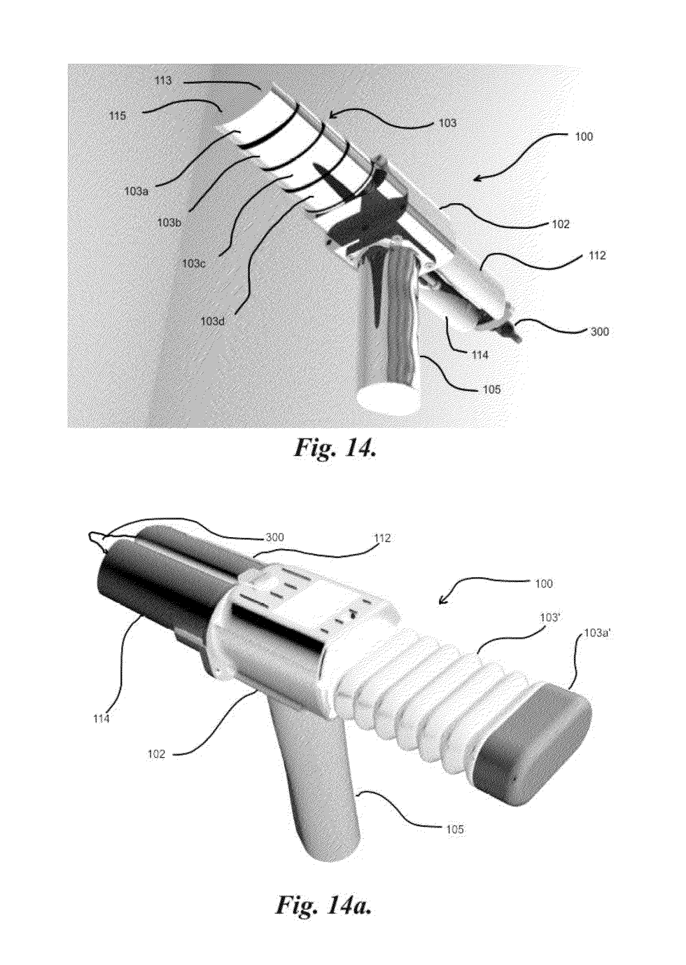

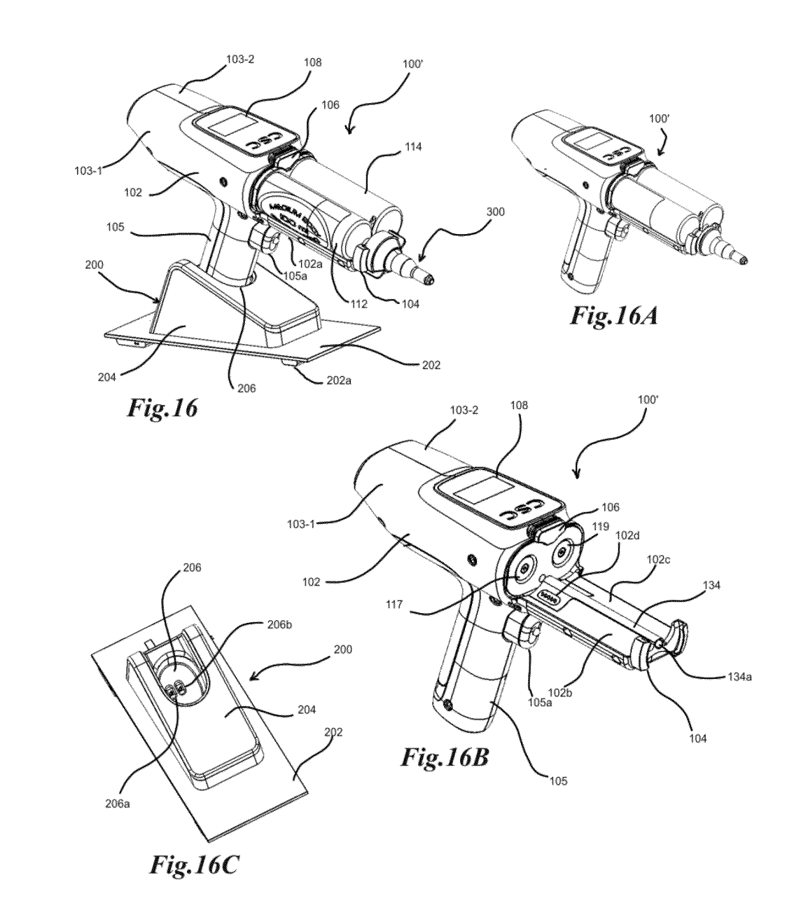

The chassis 102 may further include a handle, such as handle 105 as illustrated in FIGS. 14, 14a, or handle-like section 105, as in FIGS. 16, 16A, 16B, 17, 17A and 18, 18A-G. The handle 105 may generally be oriented such that a user may grasp it to point the mixing tip 300 in a desired direction, such as in an orientation substantially perpendicular to the axis of the mixing tip 300, as illustrated in FIGS. 14 and 14a.

The present invention may or may not have a housing for containing the gears, the drive, the vessels or compartments, and so on. In some embodiments, as shown in FIGS. 14 and 14a, the chassis 102 may also include a housing for the evacuation mechanism, such as a collapsible housing around piston rods 113, 115. A collapsible housing may generally be desirable, for example, to cover the moving components of the dispensing and/or mixing device 100, and to reduce the overall size of the device 100 as material is dispensed. Also, the degree of collapse of the collapsible housing may also serve as a general indicator of the amount and/or degree of material dispensed from the cartridges 112, 114.

In one embodiment, the collapsible housing may be a telescoping housing 103, as illustrated in FIG. 14. The telescoping housing 103 may generally include multiple sections which may nest into each other as the piston rods 113, 115 translate forward to expel material from the cartridges 112, 114, such as the multiple sections 103a, 103b, 103c, 103d, as illustrated in FIG. 14. Any other appropriate number of sections may also be utilized.

In another embodiment, the collapsible housing may be an accordion section, such as accordion housing 103′ as illustrated in FIG. 14a, which may also include a rigid cap 103a′ at the end which may couple to the ends of the piston rods 113, 115 and/or the joining bridge 116.

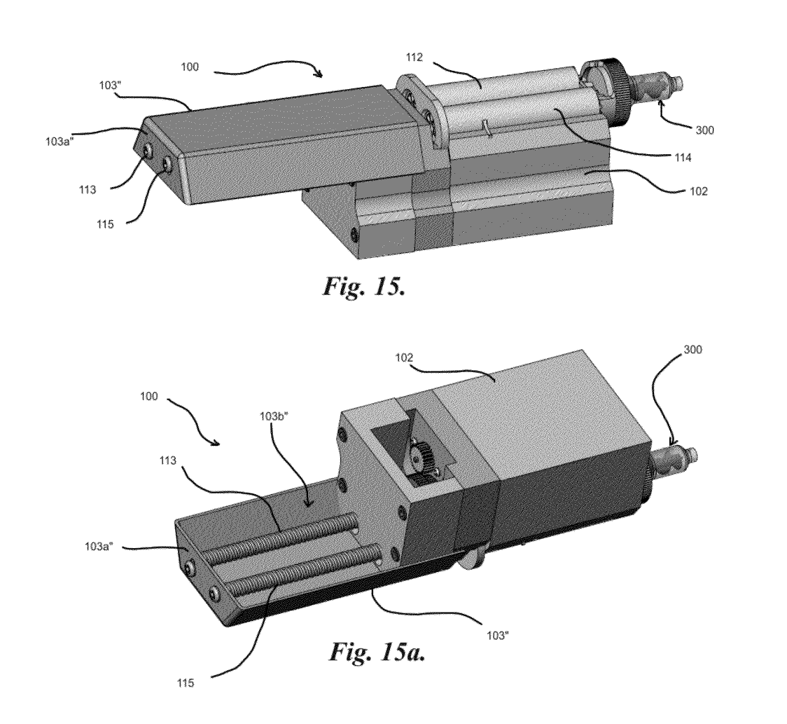

In other embodiments, the chassis 102 may include a sliding cover 103″, as illustrated in FIGS. 15 and 15a, which may generally cover the moving components of the dispensing and/or mixing device 100 in a similar manner to a collapsible housing, and where the sliding cover 103″ may generally move along the chassis 102. The sliding cover 103″ may generally be coupled to the piston rods 113, 115 at an end 103a″, such that the sliding cover 103″ may translate along with the piston rods 113, 115. The sliding cover 103″ may also generally be open, such as with open face 103b″ as illustrated in FIG. 15a, such that the sliding cover 103″ may slide over a portion of the chassis 102.

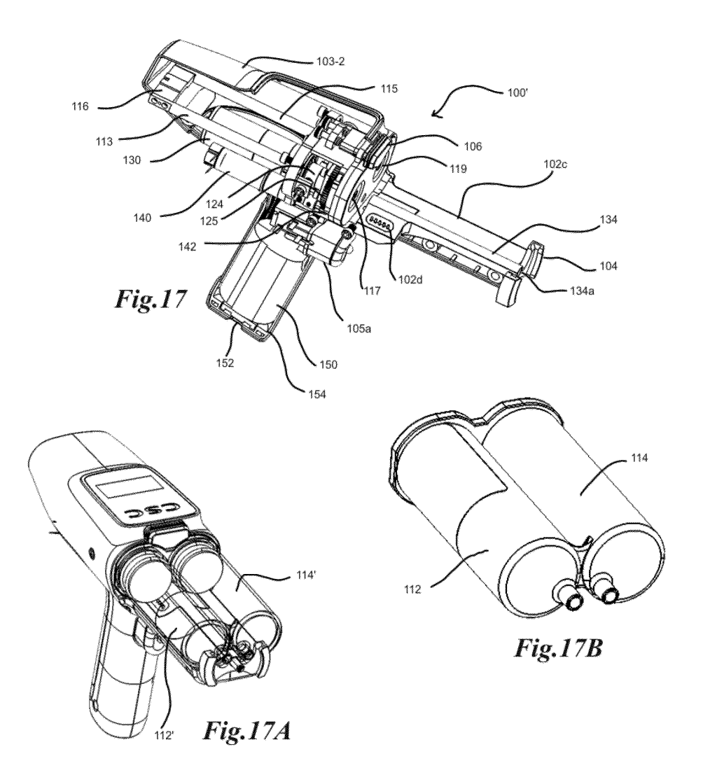

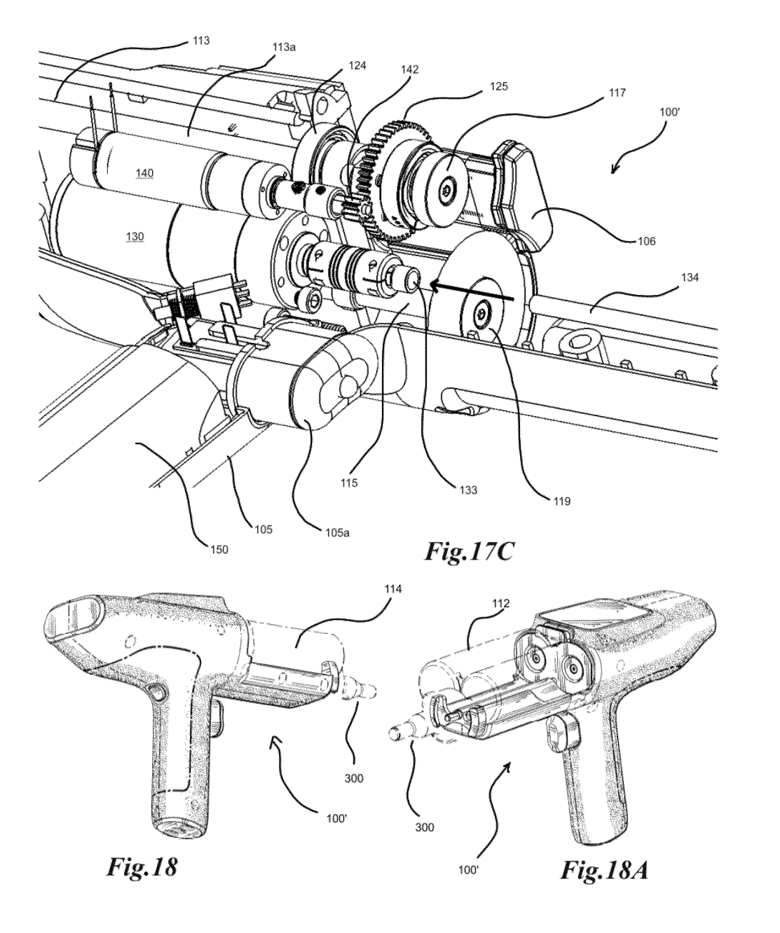

In an exemplary embodiment, such as shown with the mixing and dispensing device 100′ in FIGS. 16, 16A, 16B, the vessel portions for locating or supporting vessels or compartments 112, 114, are located in the front section of the chassis 102, as shown. This section may include a rigid housing for housing flexible vessels within, as shown with the partially transparent parts in FIG. 17A as rigid sections 112′, 114′. In other embodiments, rigid housing may not be needed when the vessels or compartments 112, 114, are of a rigid nature, such as with the removable vessels 112, 114 as illustrated in FIG. 17B. Removable vessels 112, 114 may generally sit and/or couple to the mixing and dispensing device 100′, such as at mounting spaces 102b, 102c as shown in FIG. 16B, where plunger portions 117, 119 may then press on the removable vessels 112, 114 to dispense material. The mounting spaces may also further include a mounting sensor, such as the contact sensor 102d illustrated in FIG. 16B. The mounting sensor may, for example, detect the presence and/or type of removable vessels 112, 114 when they are inserted into the mounting spaces 102b, 102c. This may be desirable, for example, to adjust the mixing and/or dispensing characteristics based on the type of materials being mixed and/or dispensed. A release and/or other locking feature, such as latch 106 illustrated in FIGS. 16, 16B, may also be included for locking and releasing the removable vessels 112, 114 from the chassis 102.

As shown in FIGS. 16, 16A, 16B and 17, the portion for locating or supporting the motors, for example, motors 130, 140, and their associated components, as well as piston rods 113, 115, is located in the rear section of the chassis 102, such as in the housing portions 103-1, 103-2. The chassis 102, instead of having a bottom section located below the front section, a handle-like section 105 is shown in FIGS. 16 and 16B. The handle-like section 105 not only serves as handle for handling or grasping the device, but may also support or locate various components of the device, such as motor accessories and power source, such as a battery or batteries, as shown with battery 150 in FIG. 17. The handle design of the device also aids to make the design of the main sections, the front and back sections of the chassis, more compact. The exact location of the handling portions may be varied and the location may be chosen to give the device a good balance when held by the dental practitioner to facilitate its use.

The mixing and dispensing device may also generally include a LED or other readout display, such as the display 108 shown on mixing and dispensing device 100′ of FIGS. 16, 16A and 16B. Any appropriate information for display, such as, for example, battery capacity, warnings, indicators, mixing/dispensing settings, etc. may be shown on the display 108. Further, the type of material, for example, light body or heavy body, may also be shown on the display as an additional check for the operator that the correct material is being dispensed for use.

The mixing and dispensing device may further generally include a mixing tip mounting 104, where a mixing tip 300 may interface with a drive mixing shaft 134 at mixing shaft interface 134a, as illustrated in FIGS. 16, 16B.

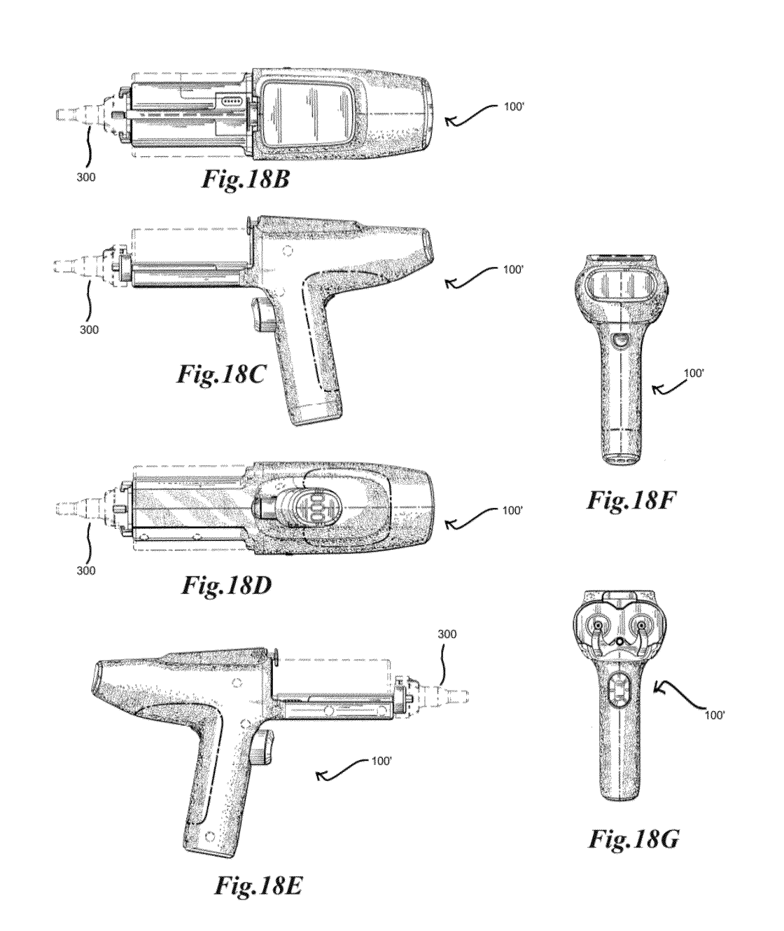

FIGS. 18, 18A show the perspective rear and side, front and side views of the device of FIGS. 16, 16A and 16B. A button-like actuator or trigger 105a, as shown in FIGS. 16, 16A, 16B may trigger or actuate the actuation of the dispensing and/or mixing action of the device. The button-like actuator, though shown to be on the front side of the handle 105, may also be located on the top of the device and may be of any other design, for example, a rocker switch. In addition, if the actuation is to be done via a foot pedal, either wired or wireless, or via voice control, no button-like structure is needed.

The vessels or compartments 112, 114, may be the actual impression material containers, if the containers have rigid bodies; or they may also be rigid coverings or housing, for housing or containing the impression material package or containers, if these are flexible containers or packages, as shown with hollow rigid sections 112′, 114′ in FIG. 17A.

FIGS. 18C, 18E show the side views of the device of FIGS. 16, 16B. Various fasteners, such as bolts or screw-like fasteners, may be used to put together the various coverings or housing parts for the chassis 102.

FIGS. 18B, 18D show the top and bottom views of the device of FIGS. 16, 16B, respectively. The contour of the covering or housing of the rear section adds to the sleek look of the device.

FIGS. 18F, 18G show the back and front views of the device of FIGS. 16, 16B, respectively.

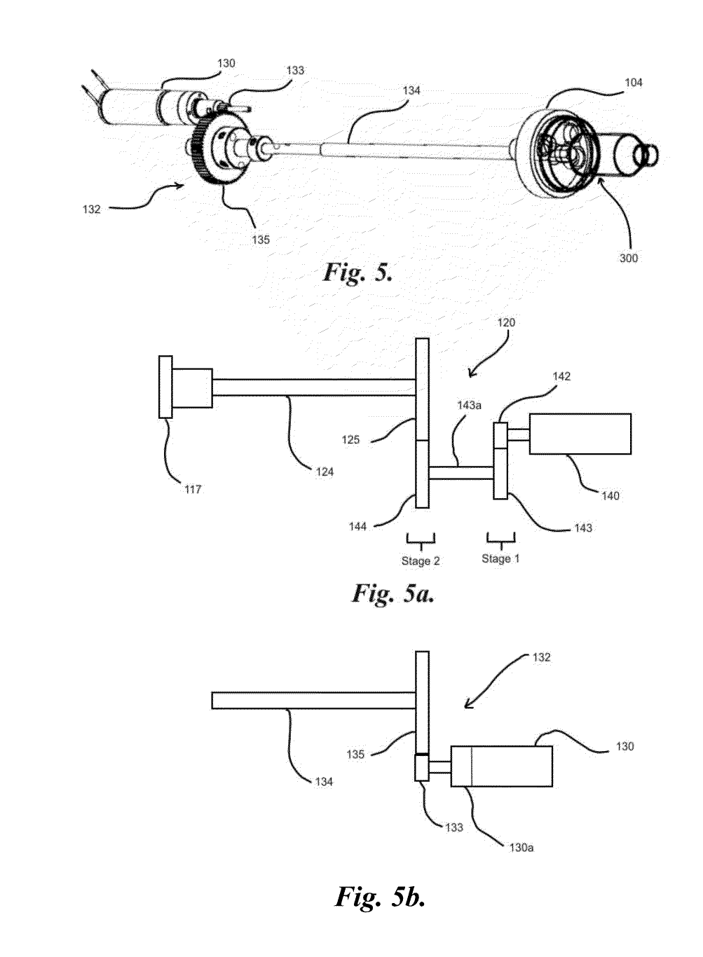

In one aspect, the mixing tip 300 may be a dynamic mixing tip and it may be driven by a separate driving system from the actuator driven by motor 140, such as by motor 130, as illustrated in FIGS. 1, 2 and 3. In general, the motor 130 may be coupled to the mixing tip 300 through a drive mixing shaft 134, which may be directly driven or by a gearing mechanism 132, as illustrated in FIGS. 2, 3 and 5. The gearing mechanism 132, similar to the gearing mechanism 120 discussed above, in general, may be optimized to provide the desired amount of rotation to the drive mixing shaft 134 and thus the mixing tip 300 while also optimizing the available power of the power source and/or the motor 130. In one embodiment, the gearing mechanism 132 may include, for example, an output gear 133, which may be coupled to the output mixing shaft of the motor 130, and a driven gear 135, which may be rotationally coupled to the driven mixing shaft 134. The gears 133, 135 may thus be used for stepping up or down the rotational speed transferred to the driven mixing shaft 134, as illustrated in FIG. 5. In general, depending on the power of the motor, the power source, the desired speeds, and/or other engineering factors, the gearing mechanism 132 may be adjusted and/or optimized to provide the desired output. In another embodiment, the gearing mechanism may be incorporated in the motor itself as a gear head.

In an exemplary embodiment, as illustrated with mixing and dispensing device 100′ of FIGS. 17 and 17C, a motor 130 may also directly drive the driven mixing shaft 134.

The gearing ratios for each of the motors may be different or the same depending on the similarity or dissimilarity of the motors for optimal performance of the motors. Multiple stages of gearing may also be utilized. For example, the output gear of a drive motor may drive an intermediate gear or gears, which may drive a driven gear, which may be coupled to a mixing shaft or a piston rod.

In one example, the motor 140 driving the piston rod 113 via nut element 124, as illustrated in FIGS. 4 and 5a, may have a stage one gear ratio matching with an intermediate gear 142 to output gear 143 ratio of about to four to six to one, more for example, about five to one and a stage two gear ratio of the driving gear 144 to driven gear 125 of about eight to twelve to one, more for example, about ten to one; the motor 130 driving the mixing tip 300 via mixing shaft 134, as illustrated in FIGS. 5 and 5b, may have a stage one gear ratio and/or gear head reduction ratio from gear head 130a to the output gear 133 of about ten to fourteen to one, more for example, about twelve to one and a stage two gear ratio matching with a ratio between driven gear 135 to the output gear 133 of about six to ten to one, more for example, about eight to one to, for example, achieve desired performance from the motors 130, 140 without, for example, unnecessarily increasing the noise output from the system. Alternative gear ratios and/or combinations of gears and/or gear heads may also be employed to further tailor the outputs of the motors 130, 140 when driving the piston rod 113 and mixing tip 300.

An exemplary embodiment of the dispensing mechanism is illustrated in mixing and dispensing device 100′ of FIGS. 17 and 17C. As illustrated, the motor 140 may drive a primary gear directly, such as output gear 142, which may be coupled to the driven gear 125, which may advance the piston rod 113 via nut element 124, which then also advances piston rod 115 via bridge 116.

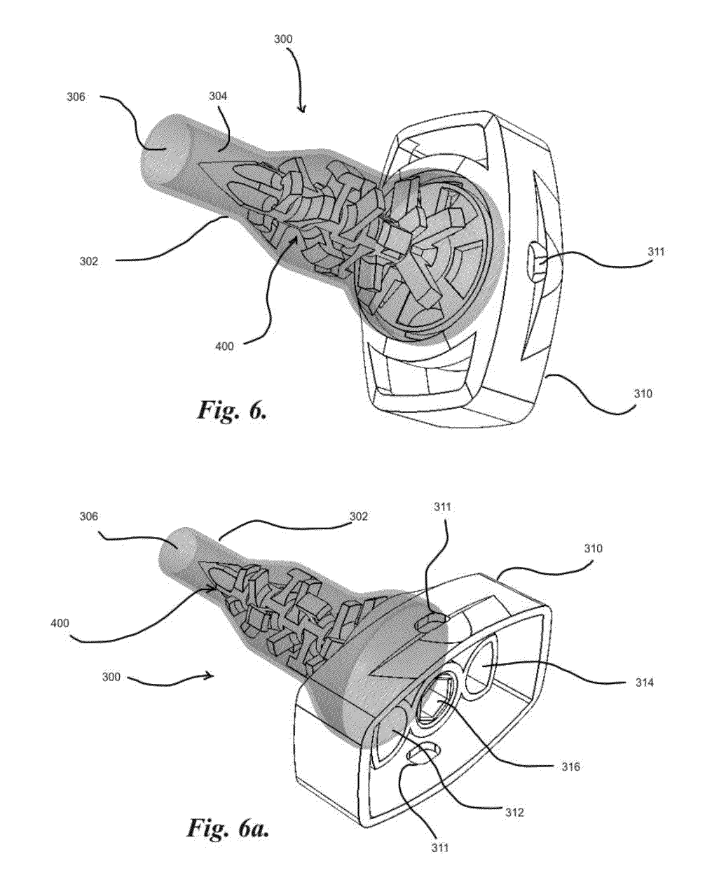

The mixing devices 300 described and contemplated herein may, in general, include a housing, for example, 302, as shown in FIGS. 6 and 6a such that some or all of the component parts, such as mixing elements, may be contained.

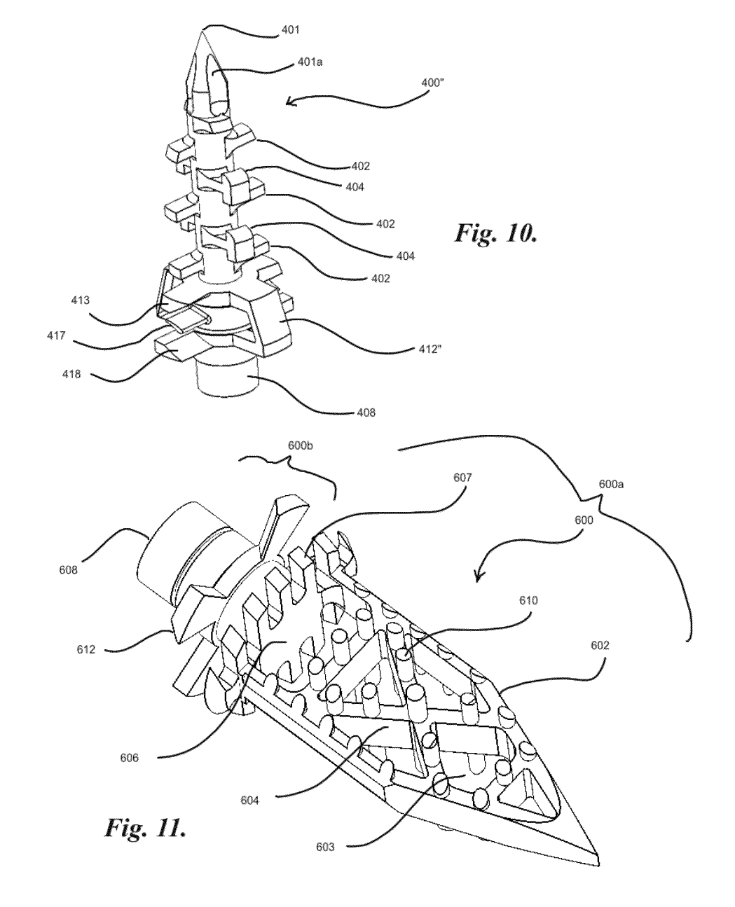

In general, a dynamic mixer 300 in operation includes a linear velocity component and a rotational velocity component. Linear velocity component generally represents the rate the material is being dispensed or evacuated while the rotational velocity component generally represents the residence time or how thoroughly the materials is being mixed in the mixer 300 prior to being evacuated. If the linear velocity component is too high, the material may not be mixed well. On the other hand, if the rotational component is too high, the dispensing or evacuation speed may be too low in practice. Thus, a dimensionless factor, for example, a churn factor (η), may be represented by the rotational velocity (ρ) divided by a linear velocity (τ). This factor η=ρ/τ, may be theoretically calculated for any embodiment of the mixing tip 300. Without wishing to be bound by a theory, it is surmised that any embodiment of the mixing elements, for example, the embodiment as shown in FIGS. 10, 11, 11a-c, 12, 12a, 13 and 13a, having a certain churn factor may be suitable. At any point along the mixing tip 300, the volumetric flow of the material, for example, an impression material, as it is being dispensed (mm³/second or inch³/second) through the equivalent cross sectional surface area (mm² or inch²) at that point. In other words, τ may represent how much material is passing through the area per unit time, which has units of either mm/s or inch/s.

ρ may be considered as the amount of material as it is being rotated (rev/s) one revolution along the perimeter of the mixing tip 300 (mm/rev). In other words ρ is the rate at which the material goes around the tip and has units of either mm/s or inch/s. Thus, the churn factor is η=ρ/τ.

The mixing capability of the mixing tip may be optimized by adjusting the ratio between the rotational and translational speed of the mixing shaft. For example, for a proper balance of mixing and evacuation speed, the churn factor may range from about five to about eighty; more for example, it may range from about eleven to about sixty-five. The efficiency of a mixer generally depends on the design of the mixing elements, the number of elements and the length of the total mixing zone. For the present invention, a compact, efficient mixer is also desired. Thus, the number of elements and the total length of the mixing zone are correspondingly smaller. Therefore, a mixer having proper elements is important to achieve proper mixing, or proper churn factor, to a greater extent than if size is not a factor.

In general, a multi-component dispensing and mixing device may include at least one vessel having dual-compartments or dual vessels for storing the material or materials to be dispensed. The vessel or vessels may be rigid or self supporting, so that they may be mounted for use without additional support, such as an external housing.

For a multi-component dispensing and mixing device that may include at least one vessel having dual-compartments or dual vessels for storing material or materials to be dispensed, the vessel or vessels may also be flexible or collapsible. In this case, an external rigid housing may be used.

The rigid vessel or rigid housing may be made of a material similar to the polymeric material that is useful for the chassis mentioned above, or any other similar material, though the requirement for structural properties may be lesser than the chassis.

For the flexible or collapsible vessels, the material may include any flexible film material, for example, polyethylene, polypropylene, polyester, polystyrene, acrylic copolymers, and so on.

In general, a foil layer or liner may be used in either rigid vessel or flexible or collapsible vessel, especially for reactive materials that may be sensitive to air or moisture.

In one aspect, as illustrated in FIG. 6, a dynamic mixing tip, such as the mixing tip 300 illustrated, may generally include a hollow housing 302 with a substantially hollow interior 304, and an outlet opening 306. The hollow housing 302 may generally be attached and/or mounted to a base portion 310 which may generally interface with the outlet ports of the compartments or cartridges of a dispensing and mixing device 100. The base portion 310 may also generally include locking features 311 which may, for example, be utilized to aid in attaching and/or retaining the mixing tip 300 on the dispensing and mixing device 100. Within the hollow interior 304, the mixing tip 300 may also generally include a mixing element 400, which may, for example, be a dynamic mixing element which may generally be propelled or otherwise utilize motion to aid in mixing. The mixing element 400 may generally be driven by interfacing with a driving feature on the dispensing and mixing device 100, such as a drive mixing shaft. Further in general, the mixing element 400 may generally be rotated either clockwise or counterclockwise, depending on the design and mode of operation, within the mixing tip 300 along an axis that runs the length of the mixing tip 300 from the base portion 310 to the outlet opening 306.

In some embodiments, such as the one illustrated in FIG. 6a, the mixing tip 300 may be in general adapted to interface with at least one outlet port of a compartment or cartridge of a dispensing and mixing device 100, such as with the two inlet ports 312 and 314 as illustrated. The inlet ports 312, 314 may in general be shaped such that they may form a secure and/or fluid-tight connection with the outlet ports of the compartments or cartridges of a dispensing and mixing device 100. Also as illustrated in FIG. 6a, the mixing tip 300 may interface with a drive mixing shaft of a dispensing and mixing device 100 at drive interface 316, which may be utilized to drive the mixing element 400. In one embodiment, the drive interface 316 may include a slot, such as the hexagonal slot illustrated in FIG. 6a, and/or any other appropriate interface such that a drive mixing shaft may interface with and drive the mixing element 400.

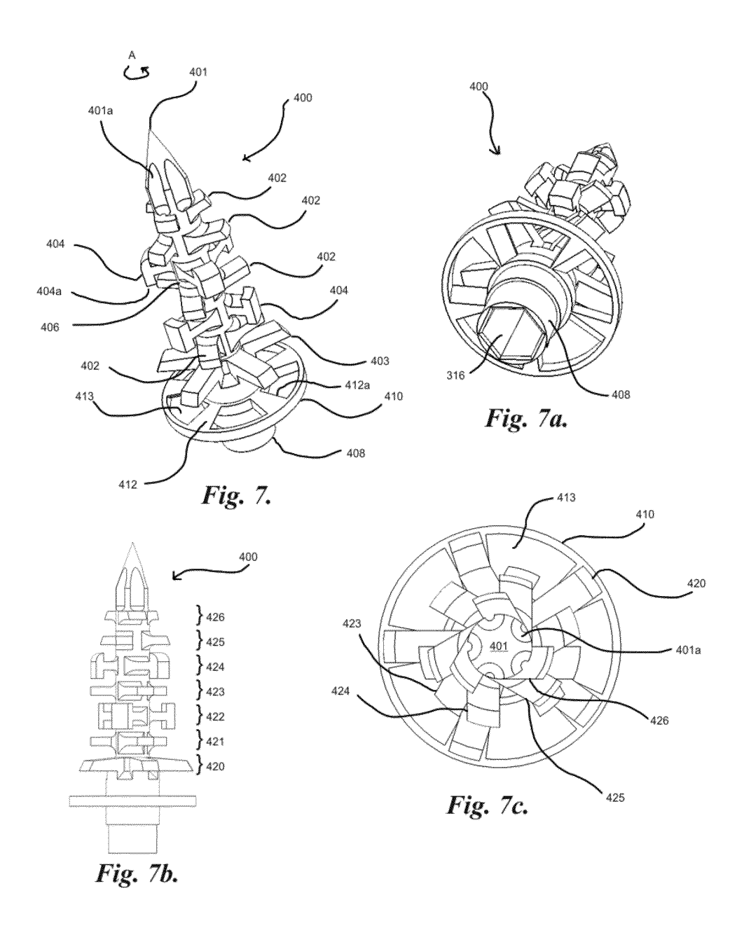

In one embodiment, as illustrated in FIG. 7, a mixing element 400 may generally include a variety of mixing features, such as the complex profiles of the blades of the types 402, 403 and 404 fixed about a central mixing shaft 406 having an outlet end 401, and a sweeping element 410, which may generally rotate in a direction A, or alternatively opposite to the direction A, by being driven by a driven mixing shaft through an interface, such as the interface 316 within the base 408 illustrated in FIG. 7a. In some embodiments, such as illustrated in FIG. 7, the mixing element 400 may include generally flat blade elements, such as the blades 402 and 403, and T-cross section blade elements, such as the blades 404. The blade elements may, for example, substantially contour to the wall of the hollow interior 304 such that the blade elements may substantially contact material along the wall of the hollow interior 304. The blades may also be generally arranged in sets, such as in sets of three or five as illustrated. The blades may further be arranged in a series of tiers or levels, such as tiers 420, 421, 422, 423, 424, 425 and 426, and ending in the output end 401 as shown in FIG. 7b. In general, the size and/or dimensions of the various mixing elements, such as the blades 402, 403, 404, for example, may be varied such that, for example, they may more closely contour the hollow interior 304, such as by, for example, being longer where the hollow interior 304 is wider and shorter where the hollow interior 304 is narrower. Furthermore, the size and/or dimensions of the various mixing elements, such as the blades 402, 403, 404, for example, may be varied such that, for example, they may maximize the churn factor without increasing the size of the mixing tip 300. Various degrees of tapering and/or other gradual size changes of the mixing features may also be utilized, for example, to account for and/or adjust to changes in the size and/or local volume of the hollow interior 304 at various locations. This may generally apply to any of the mixing features of any of the mixing elements described herein.

In general, materials for mixing and dispensing may generally enter the mixing tip 300, such as at the inlet ports 312, 314, as shown in FIG. 6a. The flows of materials may then enter the hollow interior 304 of the housing 302 where the mixing element 400 may generally combine and/or mix the materials by cutting through the flows and directing them in multiple directions within the hollow interior 304. The mixed and/or combined materials may then generally exit through the outlet opening 306. The mixing element 400 may further aid in conveying the material through the mixing tip 300 by flow manipulation and/or generating propulsive action on the materials, which may generally be tailored such that the material flows through the mixing tip 300 at a desired rate and/or maintains sufficient residence time in the mixing tip 300 for adequate mixing.

In one embodiment, the mixing element 400 may initially cut up the flows of materials using blade elements 412 of a sweeping element 410 near and/or adjacent to the inlet ports 312, 314, as shown in FIG. 6a, such as with leading edges 412a as the mixing element 400 rotates in direction A. The materials may be further mixed and/or cut up by the blade elements 402 of the subsequent tiers 420-426 before flowing through and around the cutouts 401a of the output end 401 of the mixing element 400 and then out the outlet opening 306. In some embodiments, the sets of different blade elements, such as the blades 402, 403 and 404, may be arranged in mixed orders such that the blade elements may vary from tier to tier. In one embodiment, such as illustrated in FIG. 7, substantially flat blades 403 may occupy the tier 420, as shown in FIGS. 7b and 7c, with alternating sets of blades 402 and 404 in tiers 421-425, with a final tier of blades 402 at tier 426. In general, alternating blade elements may aid in mixing of the materials and, for example, in preventing dead zones of flow by varying the mixing action. Also, for example, blades 404 may aid in sweeping material away from the walls of the hollow interior 304 using the widened T-ends 404a to, for example, contact more material.

In some embodiments, the blade elements may generally radiate outward from the central mixing shaft 406 of the mixing element 400, such as illustrated in FIG. 7c. The blade elements may also, for example, be substantially spaced evenly with each other in each tier, as illustrated, or alternatively, the spacing may be uneven. The blade elements may further be angled at particular angles from the normal of the surface of the central mixing shaft 406. The orientation of the tiers of blade elements may also be offset from each other, such as shown in FIG. 7c. In one embodiment, such as illustrated in FIG. 7c, some of the tiers may be offset such that the blade elements are arranged in a substantially twisted and/or helical arrangement. This may, for example, aid in continuously directing the flows of material through the mixing tip 300 from the inlets 312, 314 to the outlet opening 306.

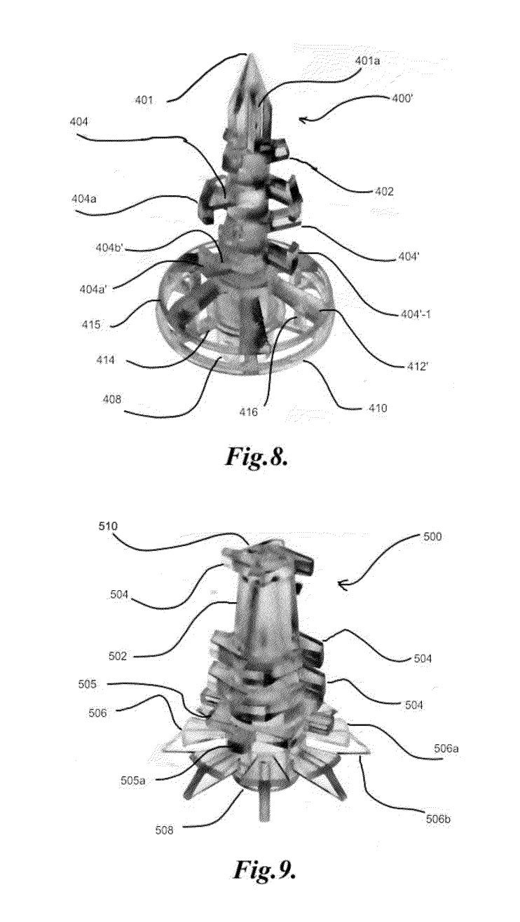

In other embodiments, a mixing element may incorporate other forms and/or combinations of a variety of mixing features which may generally be fixed about a central mixing shaft. In some embodiments, such as illustrated in FIG. 8, an example of a mixing element 400′, which may be similar in general to mixing element 400, may incorporate multiple different mixing features and may include generally flat blade elements, such as the blades 402, T-cross section blade elements, such as the blades 404, L-cross section elements, such as the blades 404′. The blade elements may, for example, substantially contour to the wall of the hollow interior 304 such that the blade elements may substantially contact material along the wall of the hollow interior 304. The blades may also be generally arranged in sets, such as in sets of three or five as illustrated. The blades may further be arranged in a series of tiers or levels, similar to the mixing element 400, as above.

In general, alternating blade elements may aid in mixing of the materials and, for example, in preventing dead zones of flow by varying the mixing action. Also, for example, blades 404 and 404′, as shown in FIG. 8, may aid in sweeping material away from the walls of the hollow interior 304 using the widened T-ends 404a and the L-ends 404a′ (or half T) to, for example, contact more material. Also for example, L-cross section blades, such as blades 404′, may generate different mixing effects, such as by utilizing different mixing profiles above and below the main blade portion 404b′ with the L-ends 404a′. This may, for example, create a generally larger space for material under the blade 404′ and a smaller space above the blade 404′. In some embodiments, the differential spaces may be utilized to control the residence time and/or flow rate of the material in the tip 300.

In some embodiments, T- or L-ends may also be utilized on different blade portions, such as, for example, shaped blades, such as fins, screws, propellers, rods, and/or any other appropriate shaped blades. In general, T- or L-ends may be utilized where it may be desirable to sweep material away from the walls of the hollow interior 304 and/or anywhere it may be desirable to create variances in the mixing action of a mixing element.

Further in general, some sets of blade elements may be oriented in opposing angles, such as the blades 404′ and 404′-1 in FIG. 8. Opposing orientations may, for example, be utilized to control the residence time and/or flow rate of the material in the tip 300. Opposing orientations may also, for further example, increase the shearing and/or mixing action between different tiers of the mixing element 400′ by altering the angle of attack between tiers of the blade elements.

Also in general, blade elements may be angled from the horizontal to, for example, control the residence time and/or flow rate of the material in the tip 300. As illustrated in FIG. 8, blades 412′ may be angled, such as for example down from the horizontal as illustrated, to increase the residence time of the material. The blades 412′ may also be angled, for example, to contour to the hollow interior 304 of the mixing tip 300 to contact material along the wall and/or eliminate dead zones similar to the T- and L-cross section blade elements 404, 404′, except along substantially the entire length of the blade 412′ as opposed to only a portion of the blades 404, 404′.

In some embodiments, as illustrated in FIG. 7, a spinning wheel-like section, such sweeping element 410, may be one tier. In other embodiments, such as illustrated in FIG. 8, a spinning wheel-like section may be a double tier arrangement, such as with wheel-like sections 410 and 415, with blades 414 and 412′, respectively. In one aspect, the two tiers are separated. In another aspect, the two tiers are connected with spokes, such as illustrated with connecting spokes 416 in FIG. 8. The connecting spokes 416 may connect the two tiers at the blades 414, 412′, as illustrated in FIG. 8, or they may connect the two tiers at different locations, such as, for example, at the periphery of the wheel-like sections 410, 415.

Still other examples of mixing features are illustrated with mixing element 500 in FIG. 9. The mixing element 500 may generally be driven by interfacing with a drive mixing shaft at the base 508, which may generally rotate the mixing shaft 502 about which mixing features may be attached and/or formed. For example, the mixing element 500 may include mixing features 504, 505, and 506. The mixing features 504 may generally include a 4-pointed twisted star blade arrangement, as illustrated. The mixing feature 505 may generally include a square blade element with protruding blades 505a extending from the sides of the square blade element, as illustrated. The mixing feature 506 may generally include a blade having a T-cross section with a vertical portion 506b and a horizontal portion 506a. The vertical portion 506b may, for example, act to scrape material from the inlets of the mixing tip 300. The horizontal portions 506a may, for example, cut up the flows of material and may also act as a delaying element to, for example, increase residence time in the mixing tip 300 by obstructing the vertical flow of the material. The horizontal portions may further aid in preventing backflow of material in a similar manner. The spacing between the different tiers of mixing features may also vary, such as the gap 502a illustrated between the mixing feature 504 and 510. Alternatively, the gaps, such as gap 502a, may incorporate other mixing features, such as any of the other discussed blade elements and/or other appropriate features. Gaps such as gap 502a may also be utilized, for example, to accommodate rings with mixing features that may slide down onto the mixing shaft 502, and may as such, for example, offer some degree of customization.

In other embodiments, such as illustrated in FIG. 10, a mixing element 400″ may include blade elements which may be substantially aligned rather than offset, such as with the aligned blades 402 and 404. Also as illustrated, conveying blade elements, such as angled blades 417 and 418, may be utilized to aid in conveying material through the mixing tip 300 by, for example, pushing material up along the sloped surface of the angled blade. Other blade elements may be oriented in an opposite orientation, such as with angled blades 413, which may impede the flow of material by pushing material back along the sloped surface of the angled blade, which may, for example, be utilized to increase residence time of the material in the mixing tip 300.

In still other embodiments, a mixing element 600 may be formed without a central mixing shaft in at least part of the mixing element 600, an example of which is illustrated in FIG. 11. Such mixing elements may, in general, include void spaces at or near the center of rotation of the mixing element in which material may flow and mix, as illustrated with void spaces 603 formed between the outer frame 602 and cross pieces 604 in FIG. 11. Mixing elements such as mixing element 600 may further be desirable as they may be formed in a largely 2-dimensional fashion, with all or substantially all of the main formations of the mixing element 600 being formed as orthogonal extensions from a plane, such as with orthogonal extensions 610 and orthogonal grating 606 with extension 607. The lengths of the orthogonal portions may be varied such that they may substantially contour the round hollow interior 304 of the mixing tip 300 as the mixing element 600 rotates. The planar portion 600a may also, for example, be formed separately from the non-planar portion 600b and then assembled together, which may, for example, ease the manufacture of the mixing element 600 as the planar portion 600a may be substantially less complex to form, such as by molding or machining More complex features, such as the round base portion 608 and the blades 612 may be formed with greater ease as well without being attached to other complex features, or, a multipart molding process may also be utilized to form the mixing element 600 as a single piece, where the relatively planar formations may contribute to ease of manufacturing.

In another aspect, mixing elements may be utilized which are designed to rotate eccentrically and/or wobble within the mixing tip 300. Examples may be similar to, for example, kitchen stand mixers which utilize a paddle or blade which rotates eccentrically to mix evenly throughout a mixing bowl which may be dimensionally larger than the paddle or blade. This may be desirable as it may increase the variance in mixing action within the mixing tip 300. A smaller mixing element may also be utilized as eccentric and/or wobbling rotation may enable the mixing element to cover more volume within the mixing tip 300. Asymmetric mixing elements may also be utilized as, for example, the asymmetry may simulate an eccentric and/or wobbling rotation.

In some embodiments, such as those illustrated in FIGS. 7, 8 and 10, the mixing elements may have pointed tips at the outlet end, such as the tip portions 401, which may include channels 401a. The channels 401a may, for example, aid in dispensing materials from the tip by effectively increasing the flow area around the tip portions 401. In some embodiments, as illustrated in FIGS. 7, 8 and 10, the channels 401a may be generally straight and in line with the axis of rotation of the mixing element. In other embodiments, the channels 401a may be angled, curved, spiraling and/or otherwise shaped and/or oriented.

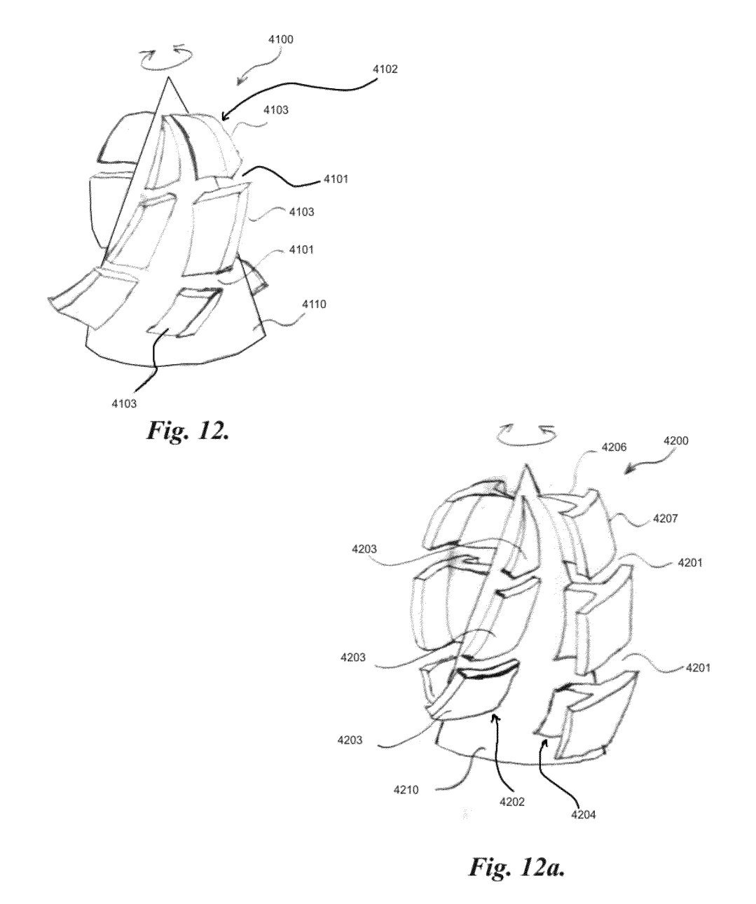

In other embodiments, a tip portion of a mixing element may incorporate other features, such as fins and/or other conveying and mixing elements, examples of which are illustrated in FIGS. 12 and 12a. The tip portions 4100 may include, for example, fins and/or baffles, such as the fin structures 4102, about the tip portion, such as a conical shaft 4110. The fins and/or baffles, such as the fin structures 4102, may be arranged to add conveying and/or mixing characteristics to the tip portion 4100, such as, for example, by arrangement in a curved or spiraling manner, as illustrated. The fin structures 4102 may also effectively create channels between them by being raised from the surface of the conical shaft 4110, or the conical shaft 4110 may also include further channels.

The fins and/or baffles, such as the fin structures 4102, may in general possess a screw-like conveying characteristic, similar to Archimedes's screws or the like. Auger like elements may also be utilized in the tip portions or in any other appropriate portion of a mixing element to achieve conveying characteristics. Such conveying type mixing features may also generally contribute to, or if in a reverse-orientation hinder, the overall force required dispense the material by creating a pressure drop across the mixing element, or in the case of a reverse-orientation, increasing the pressure head. For example, reverse auger elements may function to aid in the mixing of the materials by extending the residence time of the material inside the housing, though not to overall inhibit the dispensing of the material.

In one aspect, the portion or portions of the auger section may be shaped like a screw or propeller, and arranged in about a half spiral. In another aspect, the portion or portions of the auger section may be shaped like a screw or propeller, and arranged in less than a three-quarter spiral. In a further aspect, the portion or portions of the auger section may be partial twisted blade-like portions. In a further aspect, the portion or portions of the auger section may be partial twisted blade-like portions. According to one embodiment of any of the above embodiments, the reverse auger portion may be present in the middle of the sections. According to another embodiment of any of the above exemplary embodiments, the reverse auger portion may be present closer to the inlet than the outlet of the mixing tip.

In still a further embodiment, the mixing elements may include at least one auger-like section or element disposed thereon in combination with any of the above embodiments of portions. The auger-like section or element may, when rotated by the centrally driven mixing shaft, achieve mixing and may also provide at least a portion of the total driving force to dispense a material. The auger-like section or element may be, for example, towards the inlet end of the mixer.

In some embodiments, the tip portion 4100 may also incorporate additional mixing characteristics, such as by, for example, incorporating cutouts 4101 in the fin structures 4102. This may, for example, create discontinuous fin structures 4102 in flowing segments 4103 with cutouts 4101 between them. Material mixing may thus occur by the flow being cut and distributed at the cutouts 4101 during rotation of the tip portion 4100.

Although the discontinuous fin-like portions have been described here and above as being positioned close to the tip of the mixer, they may be presented anywhere along the mixing shaft in combination with any of the complex profile mixing elements described above in various embodiments.

In other embodiments, the tip portion may also incorporate T-shaped features, such as the T-shaped ends 4207 on the segments 4206 of fin structures 4204 on the tip portion 4200 in FIG. 12a, which may also incorporate fin structures 4202 without T-shaped features. The T-shaped ends 4207 may generally act to, for example, sweep material from the walls of the hollow interior 304 of the mixing tip 300, similarly to the other T-shaped mixing features described above. Other shaped ends may also be utilized, such as the L-shaped ends and/or any other shaped ends described above. In some embodiments, the tip portion 4200 may also form substantially all of or a significant portion of a mixing element rather than being only a tip portion.

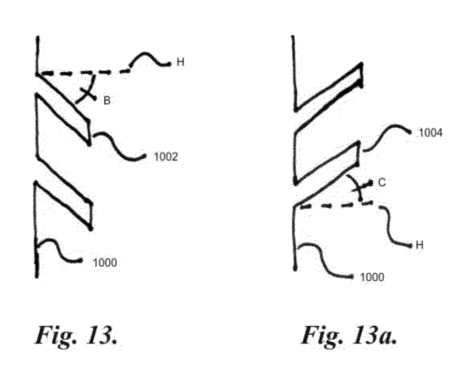

In some embodiments, including the above described embodiments, mixing features may be angled from the horizontal plane such that, for example, they may alter the mixing and/or conveying characteristics of the mixing element as materials pass through it. For example, mixing features may be angled away from the horizontal toward the base of the tip (opposite the outlet end), such as the leading edges 412a in FIG. 7, the undersides of the fins 417 in FIG. 10, or they may also be angled downward orthogonally, such as the elements 1002 away from mixing shaft 1000 at angle B from the horizontal H in FIG. 13. For further example, mixing features may also be angled away from the horizontal toward the outlet end, such as the top side of fins 417 in FIG. 10, or they may also be angled upward orthogonally, such as the elements 1004 away from mixing shaft 1000 at angle C from the horizontal H in FIG. 13a. In general, the angle of the mixing features of any of the above mixing elements may be tailored to adjust the mixing and/or conveying characteristics of the mixing element.

In general, at least three sections may be present on the mixing shaft for a given mixing element; more for example, at least four sections of mixing elements may be present on the mixing shaft; even more for example, at least five of mixing elements may be present on the mixing shaft; and still more for example, six sections of mixing elements may be present on the mixing shaft; each sections having two or more portions radiating outwardly from the mixing shaft and arranged along the mixing shaft, with the portions of at least one of the sections at a substantially right angle relationship with the mixing shaft and some of the portions of at least one section making an acute angle with the mixing shaft, extending downwards, upwards, or a combination thereof from the horizontal plane. In one aspect, the portions of the sections may be spaced at even intervals around the mixing shaft, and portions of one section being staggered from the portions of at least one other section, by, for example, five to twenty-five degrees; more for example, ten to twenty degrees. In another aspect, the portions of at least one section may be spaced at uneven intervals about the mixing shaft. In yet another aspect, the portions of all sections may be arranged at uneven intervals about the mixing shaft and staggered from the portions of at least one other section, by, for example, five to twenty-five degrees; more for example, by ten to twenty degrees. In a further aspect, the portions of all sections may be arranged at combinations of different intervals about the mixing shaft.

The mixing tip may be made from any polymeric material that imparts the mixing elements with some structural integrity that is capable of mixing and/or cutting up the material being mixed. Suitable materials may include, but not limited to, the materials mentioned above for the chassis, or less structural materials including, polyethylene, polypropylene, polybutylene, polystyrene, polyester, acrylic polymers, polyamide, or biodegradable polymers such as polyethylene oxide (PEO), polylactic acid (PLA), and similar.

The device is compact and may be held in the palm of the dental professional, or may include a handle 105 which may be attached to the chassis 102 or part of the chassis 102. Actuation of the mixing and/or dispensing action may also be controlled by, for example, a trigger and/or other finger control, as noted above. The device may also employ a pedal, such as a foot pedal, which may be wired or wireless, voice control, remote control, and/or any other appropriate control mechanism. For voice control, the device may be programmed to recognize a few words such as “get ready”, “dispense”, and “stop”. In general, the control mechanism may be adapted to enable ease of use by the dental professional, such as with many actions only requiring one hand and/or use of the feet, voice and/or other faculties which may leave the dental professional with a free hand whenever possible.

Any remote actuation or control mechanisms, such as voice control or wireless control may include buffers, identifiers and/or other controls to eliminate cross-talk between devices in close proximity. For example, wireless controls may typically use a code, channel and/or other identifying information to help ensure that commands from a wireless controller are only received and/or executed by a particular (intended) device. Software may be programmed to respond to a particular user's voice or a particular device's address and/or designation. For example, a particular device may be programmed to only respond to a particular user such that, for further example, a user will not accidentally voice control multiple devices at once. A particular device may also be given a designation such that it will respond to commands given to it based on the designation, and not to commands given to other devices. For example, a particular device may be designated “dispenser 1” and may only respond to commands addressed to “dispenser 1” by voice. This may be desirable in environments where there are multiple devices in a single space or room, or where users may engage in voice conversation which may otherwise accidentally trigger a voice command.

The device may have an internal or external power source for supplying power for mixing and/or dispensing. For an external source, a connection cable may be provided which may be extended during use and contracted during storage. The advantage of an external power supply is that it does not add weight to the device. The disadvantage is that it is tethered during use and not self contained. When the device itself is powered by an electrical source included inside the housing, such as, for example, a battery, a capacitor, a transducer, a solar cell, it is self-contained. The power source, such as battery packs, capacitors, solar cells or a transducer, etc. may be housed in the handle section 105 of the device, if the device is of gun-shaped, such as shown with battery 150 in FIG. 17, the partial cut away view of FIG. 16B.

With the recent advancement in battery technology, an internal power source may also provide the advantage of both being untethered and light weight. For example, lithium and lithium polymer type batteries are typically light weight and powerful and may be appropriate for use in the present invention.

An internal power source may also be rechargeable and an extra circuit may be added for connecting the internal power source to an external charging station, such as charging base 200 shown in FIGS. 16 and 16C. In other embodiments, the internal power source may be removable for charging externally and thus no additional circuit may be needed.

The charging station, such as charging base 200, is shown as cradle shape in FIGS. 16 and 16C, and may generally include a base portion 202 for placing on a surface with a cradle portion 204 with a recess 206 for a handle, such as the handle 105 illustrated. It may also be any other shape, to accommodate the charging end of the device. The base portion 202 may also include feet, such as feet 202a, for example, to aid in stability. The charging base 200 may also include interfaces for charging the device, such as plugs 206a, 206b illustrated in FIG. 16C for charging through contacts 152 on the handle 105 as shown in FIG. 17, or a non-contact charging system may also be utilized, such as inductive charging.

The power supply or power cord may be located anywhere inside or on the chassis 102, for example, close to the motors 130, 140, a shown in FIGS. 2, 4 and 17. For internal power, the chassis 102 may include a power source support or bracket for locating the power source, such as support 154 in FIG. 17.

While exemplified embodiments of the invention have been described and illustrated above, it should be understood that these are exemplary of the invention and are not to be considered as limiting. Accordingly, the invention is not to be considered as limited by the foregoing description, but is only limited by the scope of the claims appended hereto.

1. A compact, motorized device for dispensing and mixing components of an admixture of materials, comprising:
a chassis for supporting two vessels for containing two materials, each vessel having an inlet end and an outlet end and connected to each other towards the inlet end;
a linear drive mechanism adapted to drive one of the two vessels for evacuating the materials from both vessels simultaneously;
a mixing device attached to the outlet end of each vessel for receiving the material evacuated from the vessels, said mixing device being driven by a second drive mechanism;
at least two pulse modulation control for separately controlling the drive mechanism for evacuating and the drive mechanism for the mixing element; and
a microprocessor in communication with the pulse modulation controls for varying the speed of evacuation and mixing based on the type of materials.

2. The device of claim 1 wherein each drive mechanism is driven by a separate motor, said each motor comprises separate gearing for optimal performance.

3. The device of claim 1 further comprising a sensor mechanism adapted for sensing the viscosity of the material to allow for proper dispensing of the different materials at a predetermined speed of evacuation.

4. The device of claim 1 wherein said mixing device comprises:
a substantially hollow housing having at least one inlet, and at least one outlet;
a motorized centrally driven mixing shaft disposed inside said housing and extending substantially between said inlet and outlet of said housing; and
complex profile mixing features disposed thereon said mixing shaft, said features combined to provide a churn factor of about five to about eighty for proper mixing and dispensing.

5. The device of claim 4 wherein said complex profile mixing features comprises at least three sections of mixing elements, each section having at least two portions radiating outwardly from the mixing shaft and arranging along the mixing shaft in a substantially right angle relationship to the mixing shaft and spaced at even, uneven or combination of even and uneven intervals around the mixing shaft with portions of one section being staggered from the portions of at least one other section by about five to about twenty-five degrees.

6. The device of claim 4 wherein said complex profile mixing features comprises at least three sections of mixing elements, each section having at least two portions radiating outwardly from the mixing shaft and arranging along the mixing shaft in a direction making an acute angle with the mixing shaft and spaced at even, uneven or combination of even and uneven intervals about the mixing shaft with portions of one section being staggered from the portions of at least one other section by about five to about twenty-five degrees.

7. The device of claim 4 wherein said complex profile mixing features comprises at least three sections of mixing elements, each section having at least two portions radiating outwardly from the mixing shaft and arranging along the mixing shaft, with the portions of at least one of the sections at a substantially right angle relationship with the mixing shaft and the portions of at least one section making an acute angle with the mixing shaft, extending either downwards or upwards from the horizontal, and spaced at even, uneven or combination of even and uneven intervals about the mixing shaft with portions of one section being staggered from the portions of at least one other section by about five to about twenty-five degrees.

8. The device of claim 4 wherein said mixing feature comprises fins, blades, paddles, baffles or combinations thereof.

9. The device of claim 8 further comprising a reverse auger-like feature for increasing the time the material resides in the housing during mixing.

10. A mixing device for dispensing and mixing materials, comprising:
a substantially hollow housing having at least one inlet, at least one outlet and an inside surface;
a centrally driven mixing shaft disposed inside said housing and extending substantially between the inlet and outlet;
complex profile mixing features disposed on said mixing shaft, said complex profile mixing features comprises at least three sections of mixing elements, each section having at least two portions radiating outwardly from the mixing shaft and arranged along the mixing shaft, with the portions of at least one of the sections at a substantially right angle relationship with the mixing shaft, making an acute angle with the mixing shaft extending either downwards or upwards from the horizontal, or combinations thereof, and spaced at even, uneven or combination of even and uneven intervals about the mixing shaft with portions of one section being staggered from the portions of at least one other section by about five to about twenty-five degrees; and
shearing spokes arranged about the mixing shaft towards the inlet of the housing adapted for cutting the materials.

11. The device of claim 10 wherein said shearing spokes form a spinning wheel-like section.

12. The device of claim 10 wherein said shearing spokes are present at substantially equal intervals about the mixing shaft.

13. The device of claim 10 wherein said shearing spokes are present at substantially uneven intervals about the mixing shaft.

14. The device of claim 10 wherein at least one of said mixing elements having a T-like section end for aiding in inhibiting material from slipping by the elements along the inside surface of the housing to reintroduce the material back into the mixer housing.

15. The device of claim 10 further comprising reverse auger portions adapted from increasing the residence time of the material in the mixer.

16. A handheld, motorized device for dispensing and mixing materials, comprising:
a drive rod having an external threaded race;
a driven rod running parallel to and coupled at a distal end to said drive rod;
a drive mechanism comprising a ball screw mounted about said drive rod, said ball screw comprising:
a nut element having an internal helical race; and
a plurality of ball bearings disposed between said internal helical race and said external threaded race of said drive rod;
wherein said driven rod is linearly fixed in relation to said drive rod.

17. The device of claim 16, wherein said drive rod and said driven rod are coupled by a joining bridge.

18. The device of claim 58, further comprising a drive motor coupled to said drive mechanism.

19. The device of claim 16 further comprising at least one pulse modulation control for controlling the drive mechanism for evacuating, the drive mechanism for the mixing element or both.

20. The device of claim 19 further comprising a microprocessor in communication with the pulse modulation controls for varying the speed of evacuation and mixing based on the type of materials.
